(19) United States
(12) Patent Application Publication
(10) Pub. No.: US 2022/0314375 A1
(43) Pub. Date: Oct. 6, 2022

(54) METHODS FOR AND DEVICES PREPARED FROM SHAPE MATERIAL ALLOY WELDING

(71) Applicant: Ohio State Innovation Foundation, Columbus, OH (US)

(72) Inventors: Boyd PANTON, Columbus, OH (US); Glenn DAEHN, Columbus, OH (US); Anupam VIVEK, Columbus, OH (US)

(21) Appl. No.: 17/640,794

(22) PCT Filed: Sep. 14, 2020
(86) PCT No.: PCT/US2020/050723

§ 371 Date: Mar. 4, 2022

Related U.S. Application Data
(60) Provisional application No. 62/900,304, filed on Sep. 13, 2019.

(51) Int. Cl. B23K 35/00; B23K 20/06; B23K 35/28

(52) U.S. Cl. CPC B23K 35/004; B23K 20/06; B23K 35/005; B23K 35/286; B23K 2103/24

(57) ABSTRACT

Described herein are methods for and devices prepared from welding shape memory alloys. The weld produced from the present methods can approach 100% joint strength relative the ultimate tensile strength of the shape memory alloy, and are substantially free of heat affected zones and brittle intermetallics.

### CROSS REFERENCE TO RELATED APPLICATIONS

This application claims benefit of priority of U.S. Provisional Application No. 62/900,304, filed Sep. 13, 2019, which is incorporated herein by reference in its entirety.

### FIELD

The present disclosure is generally related to methods for and devices prepared from shape material alloy welding, in particular vaporizing foil actuator welding and laser impact welding.

### BACKGROUND

Shape memory alloys are increasingly finding applications in a range of industries including the biomedical, automotive, electronics, and aerospace industries. These applications often take advantage of their shape memory effect, pseudoelasticity, and good actuation force-to-weight ratio. However, welding shape memory alloys while retaining good joint strength is very difficult. Many of the welding methods currently used on shape memory alloys create defects at the joint in the form of relatively wide heat affect zones (HAZ) or brittle intermetallics. These defects led to reduction of tensile strength and thermal distortion of parts.

There are a variety of existing competitive technologies that have been developed for joining SMAs for actuation purposes, none of which solve the pain point of a lack of a defect-free high strength joining process for SMA devices. Gluing and soldering are low strength, brittle, and add mass to devices. Fusion welding techniques such as micro-resistance welding damage the material with heat, and cause brittle joints due to the mixing of alloying elements forming brittle intermetallics Laser welding is widely used because of its low heat input, but unfortunately it still produces brittle joints even when employing interlayers or offsetting the laser to preferentially melt one of the alloys. Rotational friction welding has also been investigated; however, the joint geometry is unsuitable for actuation, and research in the area shows issues with small process windows. Ultrasonic welding can laminate thin layers of material, but there is a current lack of ability to achieve a metallurgical bonds with SMAs, and rather mechanical pull out strength is relied on, making it unsuitable for making a low weight high strength joint. The defects mentioned above have led to reduction of tensile strength and thermal distortion of parts. These methods are also limited with respect to joint geometry (and by extension device morphologies that can be manufactured).

Accordingly, improved methods for joining SMAs are needed.

### SUMMARY

Described herein are methods of joining shape memory alloys using welding processes such as vaporizing foil actuator welding (VFAW) and laser impact welding (LIW). These methods can efficiently form high strength joints between an SMA and another metal (e.g., another SMA or a dissimilar metal, such as aluminum, titanium, or stainless steel). In some examples, the methods can be used to join a nickel-titanium alloy such as nitinol to a dissimilar metal, such as aluminum, titanium, or stainless steel. In other examples, the methods can be used to join two pieces of shape memory alloy, such as two pieces of nitinol. The resulting welds can exhibit improved properties as compared to welds formed by other methods, including welds formed by alterative welding methods such as laser welding or ultrasonic welding. For example, the resulting weld can exhibit improved joint efficiency, defined as the ratio of the joint strength to the strength of the weaker of the two elements in the joining pair, in the loading mode used in service. In some embodiments, the resulting weld can exhibit improved joint efficiency, such as a joint efficiency of at least 63% (e.g., at least 65%, at least 70%, at least 75%, at least 80%, at least 85%, at least 90%, or at least 95%) relative to the ultimate tensile strength of the shape memory alloy. In some embodiments, the resulting weld can be substantially free of heat affected zones (HAZs). In some embodiments, the resulting weld can be substantially free of continuous layers of brittle intermetallics.

For example, provided herein are methods of joining a first metal to a second metal wherein the first metal, the second metal, or a combination thereof include a shape memory alloy that employ VFAW. These methods can include positioning a metallic consumable body proximate to a piece of the first metal, accelerating the piece of the first metal by vaporizing the metallic consumable body and directing the gas pressure generated by the vaporized metallic consumable body into the piece of the first metal, and colliding the accelerated piece of the first metal into a stationary piece of the second metal, thereby joining the piece of the first metal to the stationary piece of the second metal.

Also provided is another implementation of a method of joining a first metal to a second metal wherein the first metal, the second metal, or a combination thereof include a shape memory alloy that employ LIW. These methods can include positioning a piece of the first metal over an upper surface of a stationary piece of the second metal at a first distance, positioning a target layer over at least a first location of the piece of the first metal, directing a laser beam to be incidental to the first location of the piece of the first metal for a first duration, accelerating the piece of the first metal to a first velocity and towards the upper surface of the stationary piece of the second metal, thereby joining the piece of the first metal to the stationary piece of the second metal. In some implementations, the piece of the first metal is positioned at an oblique angle with respect to the upper surface of the stationary piece of the second metal.

The methods described herein can be used to form devices including a weld joining a first metal to a second metal wherein the first metal, the second metal, or a combination thereof comprises a shape memory alloy. In some implementations, the shape memory alloy used in the weld has an ultimate tensile strength, and the weld exhibits a joint efficiency of at least 63% (e.g., at least 65%, at least 70%, at least 75%, at least 80%, at least 85%, at least 90%, or at least 95%) relative to the ultimate tensile strength of the shape memory alloy. In some implementations, the weld includes substantially no heat affected zones. In some implementations, the weld includes substantially no brittle intermetallics. In some embodiments, the device can comprise a medical device (e.g., a stent or guidewire). In some embodiments, the device can comprise an actuator.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIGS. 1A-1C illustrate a set up configuration for vaporizing foil actuator welding (VFAW).

FIG. 2A illustrates a side view of a weld formed by VFAW between a shape memory alloy and a dissimilar metal.

FIG. 2B illustrates a perspective view of the weld of FIG. 2A.

FIGS. 3A-3D illustrate a variety of welds formed by VFAW.

FIGS. 4A and 4B illustrate a piece of a shape memory alloy extruded into a perforation piece of a stainless by VFAW.

FIGS. 5A and 5B illustrate another implementation of a set up configuration for VFAW.

FIGS. 6A-6D illustrate the product of the VFAW originating from the set up of FIGS. 5A-5B.

FIGS. 7A and 7B illustrate another product of another implementation of VFAW.

FIG. 8 illustrates a side cross section view of another implementation of VFAW.

FIG. 9 illustrates a side view of another implementation of VFAW with an intermediate elastomer layer.

FIG. 10 illustrates a set up configuration for laser impact welding (LIW).

FIG. 11 illustrates the product of LIW a shape memory alloy and a dissimilar metal.

FIG. 12A is an isometric view of the experimental setup of Example 1.

FIG. 12B is a side view of the experimental setup of Example 1.

FIG. 12C is a side view of the weld structure after the experiment of Example 1.

FIG. 13A is an optical image showing the NiTi/NiTi weld interface characterization.

FIG. 13B is a SEM-BSE image of the NiTi/NiTi weld interface.

FIG. 13C is an EDS map of Ti distribution of the NiTi/NiTi weld interface.

FIG. 13D an EDS map of Ni distribution.

FIG. 14 is a NiTi/SS weld interface associated with EDS map analyses.

FIG. 15A shows a comparison of differential scanning calorimetry (DSC) testing results on the NiTi base metal.

FIG. 15B shows a comparison of DSC testing results on the NiTi/NiTi weld.

FIG. 15C shows a comparison of DSC testing results on the NiTi/SS weld.

FIG. 16 shows the microhardness distributions across the NiTi/NiTi and NiTi/SS interfaces.

FIG. 17A shows a comparison of typical load-displacement relationships of the NiTi base metal, the SS-SS welds, the NiTi/NiTi welds and the SS-NiTi welds;

FIG. 17B shows typical images for NiTi/NiTi welds before and after lap shear tests showing the fracture locations.

FIG. 17C shows a comparison of joint efficiency of NiTi/NiTi welds made by TIG welding, laser welding (LSW), and VFAW in the current work;

FIG. 17D shows a comparison of joint efficiency of NiTi/SS welds made by laser brazing (LB), LSW, and VFAW in the current work.

FIG. 18A shows the cycling tests results among the NiTi base metal after 100 cycles.

FIG. 18B shows the cycling test results among the NiTi/NiTi weld after 100 cycles.

FIG. 18C shows the cycling test results among the NiTi/SS weld after 100 cycles.

FIG. 19A shows an isometric view of the VFAW setup for Example 2.

FIG. 19B shows a top view of VFAW setup showing the PDV probe positions.

FIG. 19C shows a side view of the deformed flyer after the conduction of Example 2.

FIG. 20A illustrates the flyer velocity vs. flyer travelling distance at different PDV channel locations.

FIG. 20B illustrates the relation between impact velocity and angle from the weld center to edge.

FIG. 21A shows a schematic diagram of overall interfacial microstructure of NiTi/SS impact welds with numbers indicating discussions with subsequent figures.

FIG. 21B shows OM images for half of the cross-section of interfacial microstructures.

FIG. 21C shows schematics of detailed microstructure in different zones of the NiTi/SS impact weld.

FIG. 22A shows the unbonded zone of the NiTi/SS weld of Example 2

FIG. 22B shows an enlarged view of the unbonded zone of FIG. 22A

FIG. 23A shows the nanoporous zone of the NiTi/SS weld of Example 2.

FIG. 23B shows an enlarged view of the nanoporous zone of FIG. 23A

FIG. 24 shows the flat interface with a continuous melting layer of the NiTi/SS weld of Example 2.

FIG. 25 shows the wavy interface with a discontinuous melting and spot EDS results of the NiTi/SS weld of Example 2.

FIG. 26A shows the wavy interface with discontinuous melting of the NiTi/SS weld of Example 2.

FIG. 26B is an EDS map analysis of FIG. 26A.

FIG. 27 shows the wavy interface with shear cracks in the NiTi side of the NiTi/SS weld of Example 2.

FIG. 28 shows the wavy interface with slight shear banding in the NiTi side of the NiTi/SS weld of Example 2.

FIG. 29 shows a Focused Ion Beam removed sample in transmission electron brightfield imaging and Select Area Difraction patterns from regions indicated 1-8.

FIG. 30A shows a bright field image of the SS-NiTi weld.

FIG. 30B shows the Line EDS analysis results of FIG. 30A.

FIG. 31A illustrates the liquidus temperature solidification range.

FIG. 31B illustrates the calculation in pseudo-ternary diagrams.

FIG. 32 illustrates a comparison of the DSC curves showing the phase transformation characteristics of NiTi base metal and NiTi/SS weld.

FIG. 33 shows the Vickers microhardness distribution (panel a) across the different interfaces between NiTi and SS (panel b).

FIG. 34 illustrates a comparison of joint efficiency of NiTi/SS welds made by laser brazing (LB), LSW, and VFAW.

### DETAILED DESCRIPTION

Unless otherwise indicated, the abbreviations used herein have their conventional meaning in the art.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B). The phrases “combinations thereof” and “any combinations thereof are used synonymously herein.

As used herein, a “shape-memory alloy” includes those metals that have a predetermined geometry (i.e., shape) to which the structure made from the metal returns after being deformed. Such alloys can exhibit “pseudoelasticity” (also referred to as “superelasticity”), meaning they can exhibit reversible stress—strain behavior with strain values significantly higher than those of classic metals or alloys. Such alloys can also exhibit a shape memory effect resulting from the recovery of large strains that were induced through reorientation or detwinning. As a consequence, these alloys can undergo a reversible solid state phase transformation between a parent phase and a product phase. The shape memory alloys can include, but are not limited to, those that return to its predetermined geometry due to thermal energy (i.e., temperature), such as nitinol, and/or the influence of a magnetic field. Other examples of shape memory alloys include those composed of titanium-palladuim-nickel, nickel-titanium-copper, gold-cadmium, iron-zinc-copper-aluminum, titanium-niobium-aluminum, hafnium-titanium-nickel, iron-manganese-silicon, nickel-titanium, nickel-iron-zinc-aluminum, copper-aluminum-iron, titanium-niobium, zirconium-copper-zinc, and nickel-zirconium-titanium.

As used herein, the term “heat affected zone” refers to a non-melted area of metal that has undergone changes in material properties as a result of being exposed to high temperatures during a welding process.

As used herein, the term “intermetallic” refers to a phase that forms during similar and dissimilar metal welding. Intermetallics often have low ductility and high hardness, making them detrimental to joint properties, and in worst cases makes forming a joint impossible.

Methods

Described herein are methods of joining shape memory alloys using welding processes such as vaporizing foil actuator welding (VFAW) and laser impact welding (LIW). These methods can efficiently form high strength joints between an SMA and another metal (e.g., another SMA or a dissimilar metal, such as aluminum, titanium, or stainless steel). In some examples, the methods can be used to join a nickel-titanium alloy such as nitinol to a dissimilar metal, such as aluminum, titanium, or stainless steel. In other examples, the methods can be used to join two pieces of shape memory alloy, such as two pieces of nitinol. The resulting welds can exhibit improved properties as compared to welds formed by other methods, including welds formed by alterative welding methods such as laser welding or ultrasonic welding. For example, in some embodiments, the resulting weld can exhibit improved joint efficiency, such as a joint efficiency of at least 63% (e.g., at least 65%, at least 70%, at least 75%, at least 80%, at least 85%, at least 90%, or at least 95%) relative to the ultimate tensile strength of the shape memory alloy. In some embodiments, the resulting weld can be substantially free of heat affected zones (HAZs). In some embodiments, the resulting weld can be substantially free of brittle intermetallics.

For example, provided herein are methods of joining a first metal to a second metal wherein the first metal, the second metal, or a combination thereof include a shape memory alloy that employ VFAW. These methods can include positioning a metallic consumable body proximate to a piece of the first metal, accelerating the piece of the first metal by vaporizing the metallic consumable body and directing the gas pressure generated by the vaporized metallic consumable body into the piece of the first metal, and colliding the accelerated piece of the first metal into a stationary piece of the second metal, thereby joining the piece of the first metal to the stationary piece of the second metal.

Also provided is another implementation of a method of joining a first metal to a second metal wherein the first metal, the second metal, or a combination thereof include a shape memory alloy that employ LIW. These methods can include positioning a piece of the first metal over an upper surface of a stationary piece of the second metal at a first distance, positioning a target layer over at least a first location of the piece of the first metal, directing a laser beam to be incidental to the first location of the piece of the first metal for a first duration, accelerating the piece of the first metal to a first velocity and towards the upper surface of the stationary piece of the second metal, thereby joining the piece of the first metal to the stationary piece of the second metal. In some implementations, the piece of the first metal is positioned at an oblique angle with respect to the upper surface of the stationary piece of the second metal.

These methods are described in more detail below. Aspects of these methods are also described in U.S. Pat. No. 9,021,845 to Vivek et al., U.S. Pat. No. 9,192,056 to Rubenchik et al., and U.S. Patent Application Publication No. 2012/0103949 to Daehn et al., each of which is incorporated herein by reference in its entirety.

Vaporizing Foil Actuator Welding (VFAW)

Regarding the process behind vaporizing foil actuator welding (VFAW), a high amount of charge can be stored in a capacitor bank and rapidly discharged across a thin conductor, instantly vaporizing the thin conductor and thus creating a high pressure region around the area of vaporization. The gases or plasma created from this event can efficiently propel sheets, tubes, wires etc. to very high speeds. In these methods, a metallic consumable body can be rapidly vaporized by passing a high current through the metallic consumable body and the pressure created from the vaporization is used to drive a first piece of a first metal into a stationary piece of a second metal to form a VFAW weld. The first metal, the second metal, or a combination thereof including a shape memory alloy. The shape memory alloy may be pseudoelastic or shape memory. In some cases, when stainless steel and nitinol are welded together through VFAW, the weld can have a joint efficiency approaching 100% (e.g., greater than 90%, or greater than 95%) based off the ultimate tensile strength of nitinol. In some cases, when stainless steel and nitinol are welded together through VFAW, the weld can be substantially free of heat affected zones (HAZ) and/or brittle intermetallics.

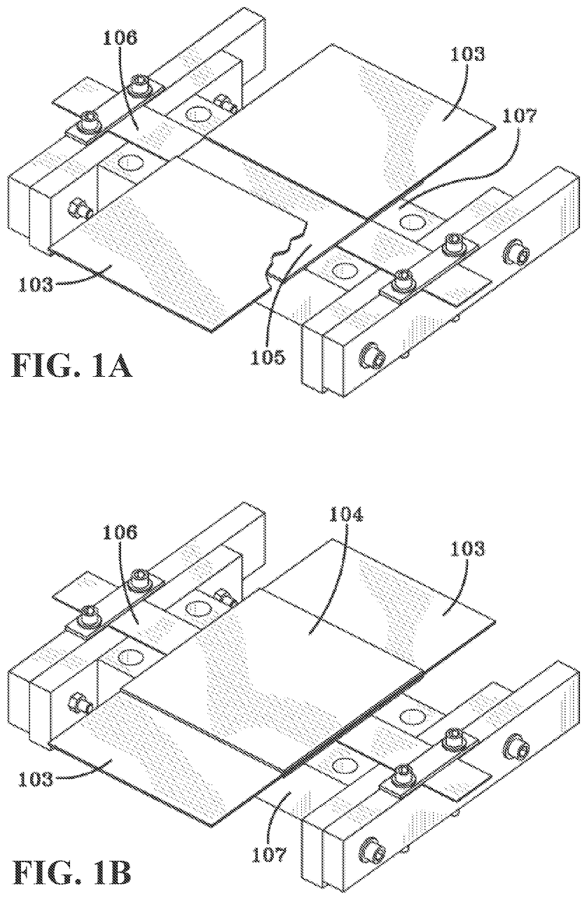

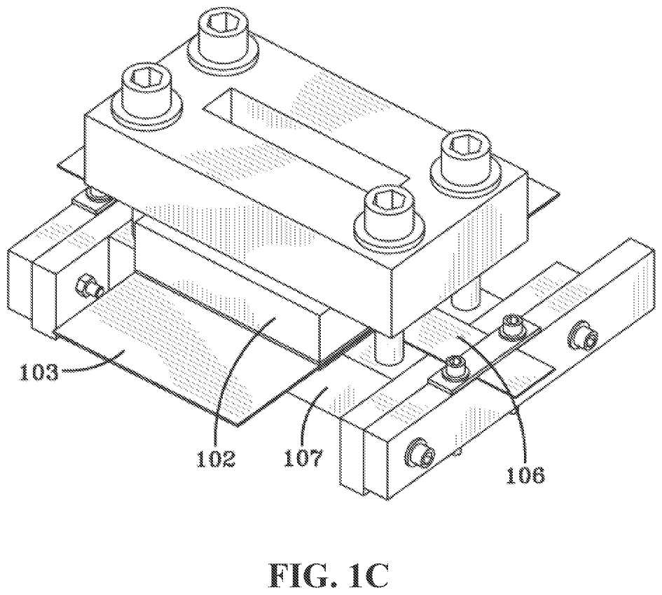

Referring now to the example configuration shown in FIG. 1A, a metallic consumable body 106 can be positioned below a flyer plate 105. Two standoff sheets 103 can be positioned atop the flyer plate 105. The metallic consumable body 106, the flyer plate 105, and the two standoff sheets 103 can be supported by backing block 107.

The metallic consumable body 106 in FIG. 1A can be a piece of aluminum foil with a thickness of 0.05 mm. In some implementations, the metallic consumable body is any metallic foil. In some implementations, the metallic consumable body can be coated with an ablative layer such as a carbonaceous material, cellulosic material (e.g., a cellophane-type material), nitromethane-based material, azide-based material, oxidizer-oxidant material, nanopowder material, any material with a rapid exothermic reaction, or any combination thereof. In some implementations, the metallic consumable body includes precision guide holes. In some implementations, the metallic consumable body has a thickness which varies depending on the process employed.

The flyer plate 105 can be a sheet of stainless steel. In some implementations, the flyer plate can comprise a shape memory alloy, a pseudoelastic alloy, a nickel alloy, a radio-opaque alloy, stainless steels, a titanium alloy, an aluminum alloy, an advanced structural metal, a refractory metal, a refractory alloy, or an amorphous metal. Possible shape memory alloys include but are not limited to nickel-titanium shape memory alloys, such as a nickel-titanium-iron (Ni—Ti—Fe) alloy, a nickel-titanium-copper (Ni—Ti—Cu) alloy, a nickel-titanium-lead (Ni—Ti—Pb) alloy, or a nickel-titanium-hafnium (Ni—Ti—Hf) alloy, Ni—Ti—Pd, Ni—Ti—Hf—Zr, NiTi—Zr, or NiTi—Er. Other possible shape memory alloys include, but are not limited to copper-aluminum SMAs (e.g., Cu—Al—Ni, Cu—Al—Nb), cobalt-based SMAs (Co—Al, Co—Ni—Al), nickel-aluminum SMAs (Ni—Al), nickel-manganese SMAs (Ni—Mn, Ni—Mn—Ga), Zr—Cu, U—Nb, titanium-based SMAs (Ti—Nb, Ti—Pd, Ti—Au, Ti—Pt—Ir), Ta—Ru, and Nb—Ru. Examples of advanced structural metal include but are not limited to high entropy alloys, nanostructured metals, nanostructured alloys, metallic glasses, bulk metallic glasses, superalloys, hot stamped steels, martensitic steels, and ultrahigh strength metals. In some implementations, the flyer plate can comprise a sheet. In other implementations, the flyer plate can comprise a wire, a group of wires previously welded together, or any other possible shape or configuration.

The two standoff sheets 103 can be, for example, rectangular sheets and each have a thickness of 0.8 mm. In some implementations, each standoff sheet has the same thickness. In some implementations, the thickness of each standoff sheet ranges from 0.1 mm to 1 cm. In some implementations, no standoff sheets are used.

In FIG. 1B, the target plate 104 can be positioned onto the two standoff sheets 103. The target plate 104 can be a sheet of nitinol (NiTi). In some implementations, the target plate can comprise a shape memory alloy, a pseudoelastic alloy, a nickel alloy, a radio-opaque alloy, an advanced structural metal, a refractory metal, a refractory alloy, stainless steels, a titanium alloy, an aluminum alloy, or an amorphous metal. Possible shape memory alloys include but are not limited to nickel-titanium shape memory alloys, such as a nickel-titanium-iron (Ni—Ti—Fe) alloy, a nickel-titanium-copper (Ni—Ti—Cu) alloy, a nickel-titanium-lead (Ni—Ti—Pb) alloy, or a nickel-titanium-hafnium (Ni—Ti—Hf) alloy, Ni—Ti—Pd, Ni—Ti—Hf—Zr, NiTi—Zr, or NiTi—Er. Other possible shape memory alloys include, but are not limited to copper-aluminum SMAs (e.g., Cu—Al—Ni, Cu—Al—Nb), cobalt-based SMAs (Co—Al, Co—Ni—Al), nickel-aluminum SMAs (Ni—Al), nickel-manganese SMAs (Ni—Mn, Ni—Mn—Ga), Zr—Cu, U—Nb, titanium-based SMAs (Ti—Nb, Ti—Pd, Ti—Au, Ti—Pt—Ir), Ta—Ru, and Nb—Ru. Examples of advanced structural metal include but are not limited to high entropy alloys, nanostructured metals, nanostructured alloys, metallic glasses, bulk metallic glasses, superalloys, hot stamped steels, martensitic steels, and ultrahigh strength metals. In some implementations, the target plate can comprise a sheet. In other implementations, the target plate can be a serrated plate, wire, a group of wires previously welded together, a casting, or any other possible shape or configuration.

In FIG. 1C, a steel block 102 can be secured onto the backing block 107 such that the target plate 104 remains stationary during VFAW. The steel block 102 and the backing block 107 can outweigh the flyer plate 105 such that when the metallic consumable body 106 vaporizes, the steel block 102 and the backing block 107 do not substantially move. After the attachment is secured, the ends of the metallic consumable body 106 are connected to terminals of a capacitor bank. When the capacitor bank is discharged, a high current, on the order of 100 kAmps, flows through the metallic consumable body 106 in tens of microseconds. In some implementations, the capacitor provides an input energy in the range of 100 joules to 100 kilojoules.

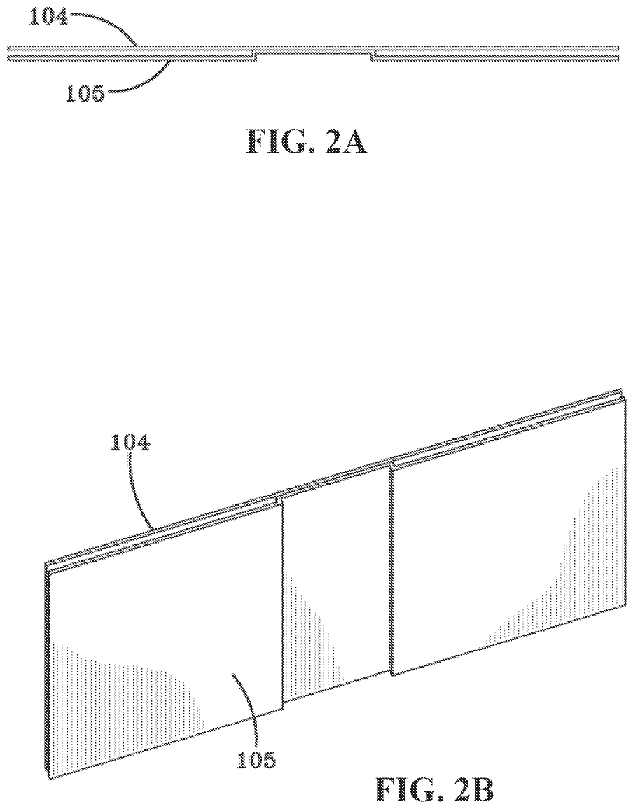

When the metallic consumable body 103 vaporizes, the reaction forces are driven largely towards the flyer plate 105. The reaction forces accelerate the flyer plate 105 to a speed in the range of 300 to 1000 m/s towards the target plate 104 which is stood-off in accordance with the thickness of the standoff sheets 103. Upon impact, the flyer plate 105 and the target plate 104 weld with each other. The product of the aforementioned VFAW process is illustrated in FIGS. 2A and 2B.

As shown in FIGS. 2A and 2B, the flyer plate 105 has a first thickness and the target plate 104 has a second thickness. In some implementations, the first thickness and the second thickness are in the range of 10 μm to 4 cm. In some implementations, the first thickness is 20% less than the second thickness.

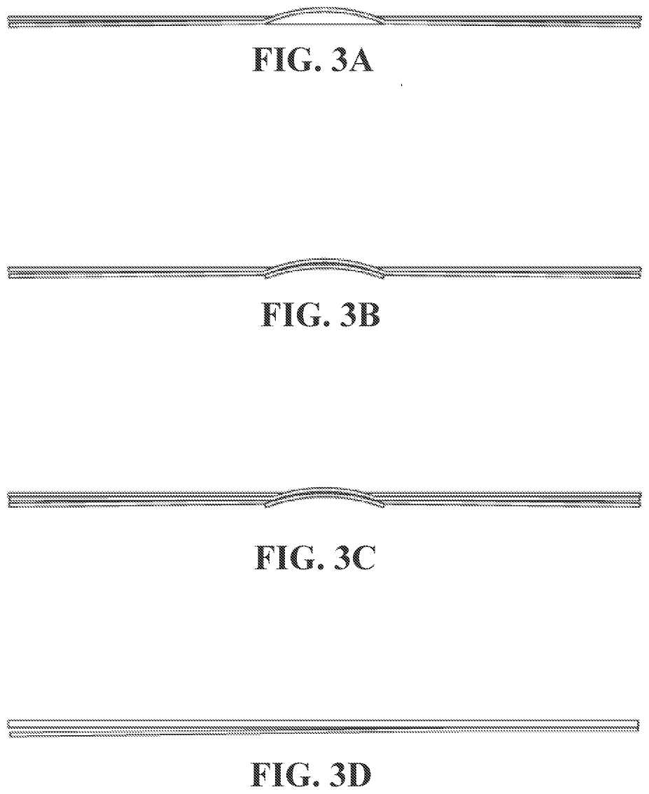

FIGS. 3A-3D illustrate a variety of possible welds. In some implementations, the aforementioned VFAW process produces a single wire weld, a plurality of wire welds, a lap weld, a scarf weld, a ring/sleeve weld, a plug weld, or an additive flyer weld. In some implementations, when the flyer plate is a wire and the metallic consumable body further includes large flat plate between the wire and the metallic consumable body. The large flat plate can distribute the pressure from the vaporization or the metallic consumable body and drives the wire to join to the target plate. In some implementations, flyer plate and target plate configurations vary such that the flyer plate and the target plate are both wires, or the flyer plate is a wire and the target plate is a flat sheet. In some implementations, the flyer plate is intermixed with the target plate.

In some implementations, the flyer plate 105 or target sheet 104 may have additional surface features to ensure oblique impact. Two, three, and four aluminum sheets have been welded together using this method in single shots. Furthermore, in some implementations, VFAW creates welds between dissimilar metal such as nitinol-stainless steel, nitinol-nitinol, aluminum-steel, aluminum-iron, titanium-stainless steel and magnesium-aluminum.

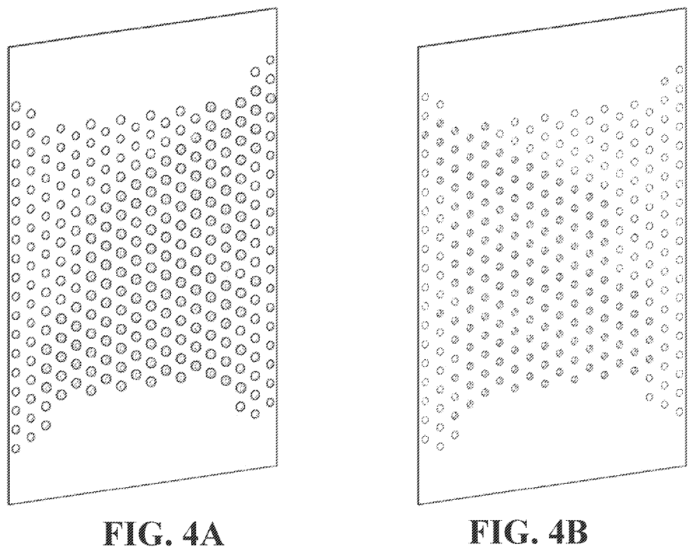

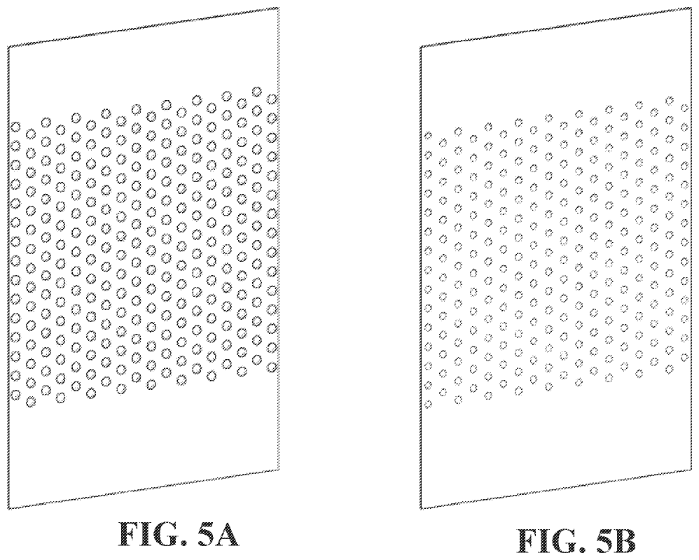

In some implementations, a layer of polyurethane (elastomer) between the metallic consumable body and the flyer plate helps in transferring the pressure and distributing it over a larger area of the flyer plate. Although the polyurethane is referred to as being part of the consumable body that accelerates the workpiece, it will be readily understood that, in many instances, the polyurethane will survive the process and be able to be re-used. As in the case of welding, in this setup also, an insulated aluminum foil is vaporized by passing a high amount of charge stored in a capacitor bank. Once the pressure wave created from rapid vaporization gets to the workpiece, it accelerates the latter to a velocity in excess of 200 m/s, almost instantly. The workpiece then gets formed into a die. Presently, stainless steel has been extruded into a perforated nitinol sheet as shown in FIGS. 4 and 5.

There are two noteworthy observations from FIGS. 4 and 5. First, tremendous pressures are being created and transferred into the workpieces. In order to get similar deformations in a traditional press, very high pressures will be required. Impact creates very high pressure in the present method. Second, the pressure is distributed in a much larger area than the area of the foil. This is enabled by using polyurethane as a pressure transfer medium.

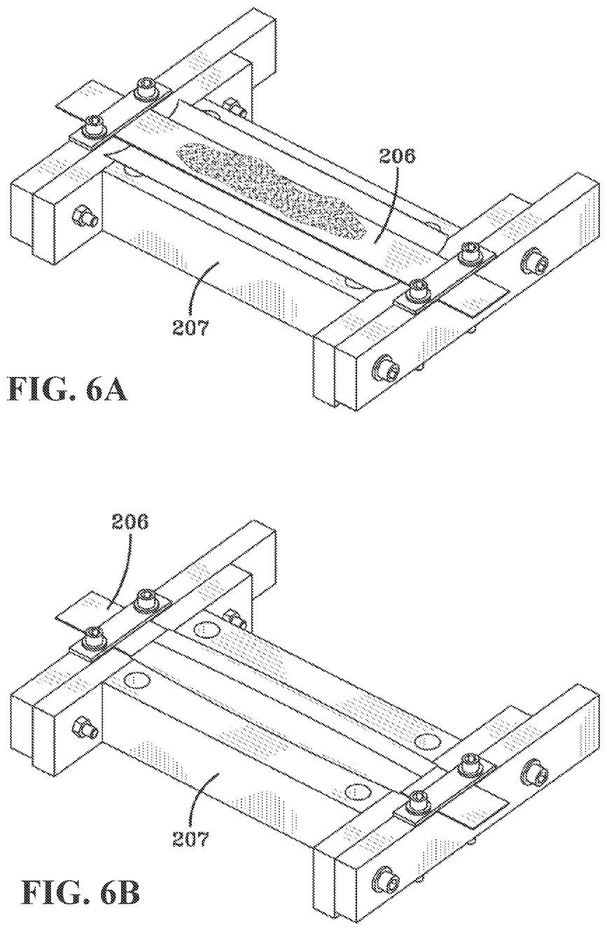

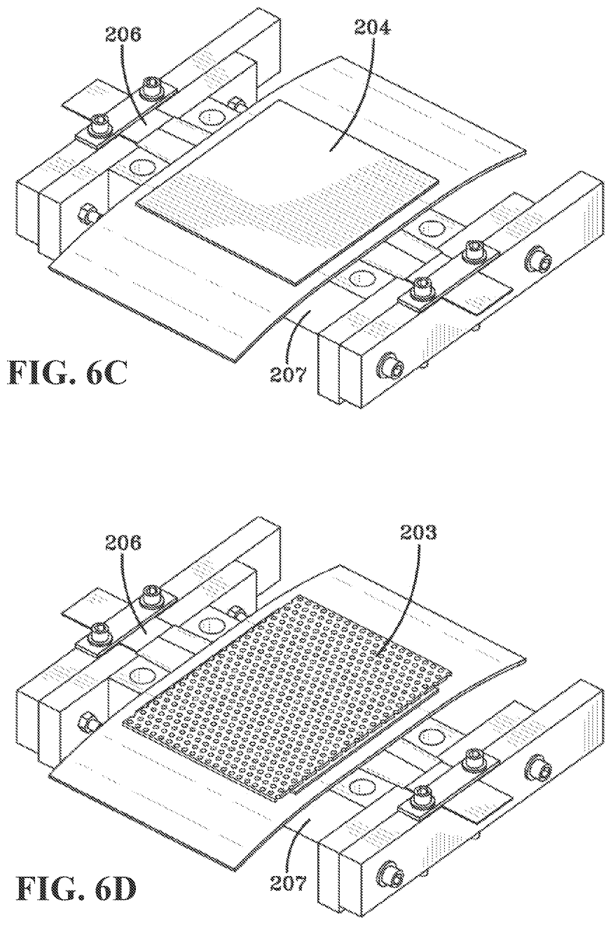

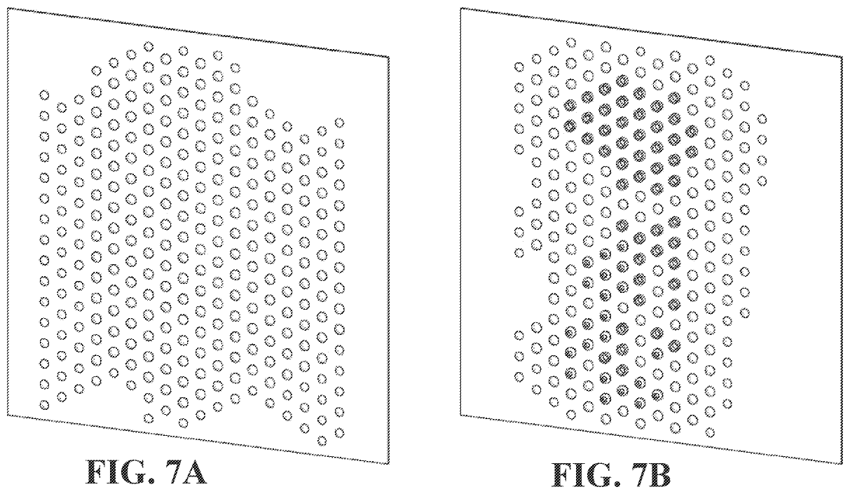

In order to get even higher discharge energies and flyer speeds, an exothermic chemical compound or mixture, such as an oxidizer fuel mixture can be placed between two layers of aluminum foil as shown in FIG. 6. The pressure created from vaporizing foils causes detonation of the mixture and leads to formation of even more gaseous products. Also, since the current is flowing in the same direction in both layers of foil, they are attracted towards each other by Lorentz forces and assist in increasing the detonation pressure on augment layer. As seen in FIG. 7, there is a significant increase in pressure by including an augment.

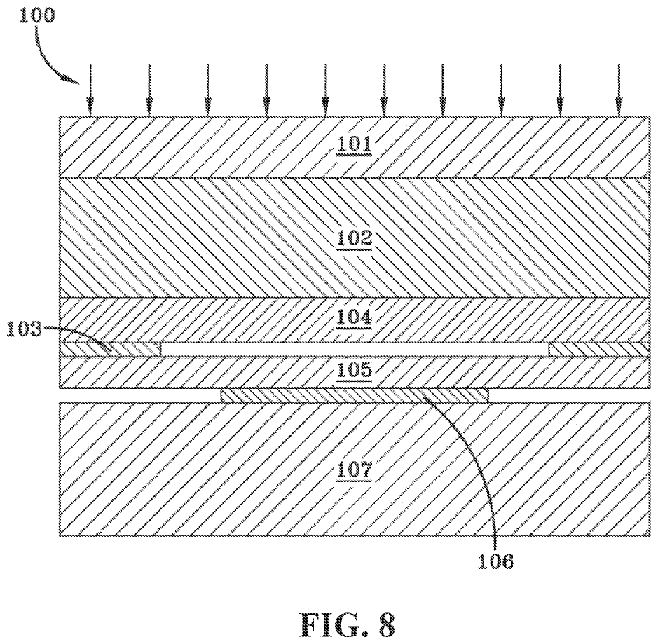

FIG. 8 illustrates a cross section of a system that is similar to the implementation of FIGS. 1A-1C. The system implements VFAW by using the pressure created by vaporizing the metallic consumable body 106 to drive the flyer plate 105 towards the target plate 104. The metallic consumable body 106 is connected to the terminals of a capacitor bank. The metallic consumable body 106 is insulated from its surroundings using a polyimide tape. When a high transient current is passed through the metallic consumable body 106, the metallic consumable body 106 vaporizes in a few microseconds. The resulting vapors also form oxides and nitrides, the reactions for which are very exothermic and cause further expansion of gases. The gases cannot move the heavy backing block 107, so the gases force the flyer plate 105 upward. The flyer plate 105 travels a certain distance and impacts the target plate 104 at a certain angle. The distance of travel and impact angle is determined by the thickness of the standoff sheet 103. In some implementations, the flyer plate 105 or the target plate 104 has engraved surface features to ensure oblique impact. The target plate 104 is backed by a steel block 102. The entire system is clamped together with the help of clamping force 100 provided by either through bolts or a hydraulic press.

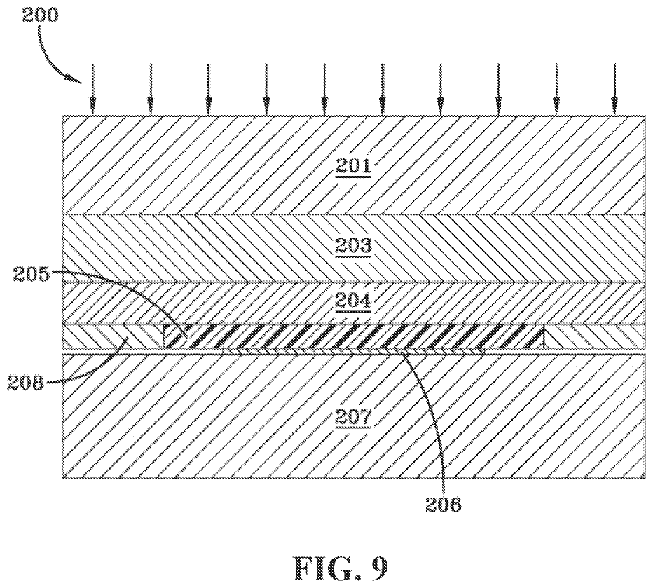

FIG. 9 illustrates a cross section of a system that is similar to the implementation shown in FIGS. 6A-6D. The system implements VFAW with augmented foil vaporization by a capacitor bank discharge. The system includes a layer of polyurethane pad 205 between the metallic consumable body 206 and a piece of sheet metal 204. The pressure created from this rapid vaporization causes detonation of oxidizer-fuel mixture (potassium chlorate and kerosene oil in current set up) leading to even higher pressures. The pressure wave travels through the polyurethane layer and pushes the sheet metal 204 into a perforated plate/female die 203, thereby forming the sheet metal 204. The perforated plate/die is backed by a heavy backing block 202. Like welding set up, clamping force 200 provides a compressive force in the vertical direction. The polyurethane pad 205 may be placed in a steel channel 208 to ensure the pressure wave travels vertically and gets efficiently coupled to the sheet metal 204.

Laser Impact Welding

Laser impact welding uses intense laser discharges or some other energy source to provide a mechanical impulse to a metal surface by one of a variety of mechanisms. Direct reflection of photons provides some level of force and impulse. Also, the surface of the metal may ablate under the beam and this generated gas can also produce a pressure that accelerates the flyer. The metal surface may also be coated with a polymer or other material that better absorbs optical energy and/or is more easily ablated. This can generate the same impulse at reduced laser energy. One additional way to increase the efficiency of converting the optical energy to mechanical impulse is by placing an optically transparent material opposed to the ablated surface to provide a surface to oppose the generation of the expanding gas. This will help to accelerate the flyer plate.

One advantage of this technique over electromagnetic or explosive launching is that the shock can be directed to a precise location (sub-micron precision) and at a precise time (precision of <10-5 seconds). The ability to apply enormous pressure at exact and localized points on a material interface and to do so with timing accuracy allows these methods to create welds in applications involving micro/nano interfaces.

LIW produces a spot impact weld between a first part and a second part. The method is conducted by providing the first and second parts, with a portion of the first part extending bent at an angle out of a generally planar surface of the remainder of the first part. The first and second parts are positioned on a support backing, with the second part between the first part and the support backing. The first part is positioned so that the second part underlies at least the bent portion of the first part with the bent portion bent away from the second part. A laser is aligned to direct its emitted energy at a top surface of the bent portion. At least one pulse of optical energy is directed from the laser onto the top surface, the amount of energy being sufficient to cause the bent portion to straighten and impact the underlying second part with a velocity of at least 300 m/s, resulting in a metallurgical bond between the respective parts.

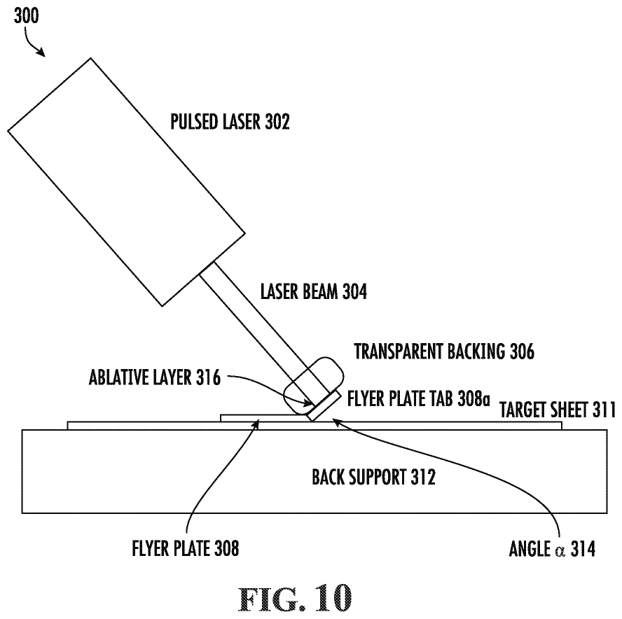

FIG. 10 depicts a system 300 in accordance with one implementation of LIW. The system includes a high powered laser 302 aimed at a flyer plate 308 positioned on a target sheet 310 such that the flyer plate tab 308a will be welded onto the target sheet 310. The target sheet 310 is supported by a rigid back support 312. The angle α 314 between the flyer plate tab 308a and target sheet 310 is about 15 degrees, but, in some implementations, the angle falls into the range of 5 degrees to 30 degrees. In some implementations, an offset distance without an angle is also permitted such that the two surfaces to impact at an appropriate angle for impact welding.

The flyer plate 308 can be, for example, a sheet of stainless steel. In some implementations, the flyer plate can comprise a shape memory alloy, a pseudoelastic alloy, a nickel alloy, a radio-opaque alloy, stainless steels, a titanium alloy, an aluminum alloy, an advanced structural metal, a refractory metal, a refractory alloy, or an amorphous metal. Possible shape memory alloys include but are not limited to nickel-titanium shape memory alloys, such as a nickel-titanium-iron (Ni—Ti—Fe) alloy, a nickel-titanium-copper (Ni—Ti—Cu) alloy, a nickel-titanium-lead (Ni—Ti—Pb) alloy, or a nickel-titanium-hafnium (Ni—Ti—Hf) alloy, Ni—Ti—Pd, Ni—Ti—Hf—Zr, NiTi—Zr, or NiTi—Er. Other possible shape memory alloys include, but are not limited to copper-aluminum SMAs (e.g., Cu—Al—Ni, Cu—Al—Nb), cobalt-based SMAs (Co—Al, Co—Ni—Al), nickel-aluminum SMAs (Ni—Al), nickel-manganese SMAs (Ni—Mn, Ni—Mn—Ga), Zr—Cu, U—Nb, titanium-based SMAs (Ti—Nb, Ti—Pd, Ti—Au, Ti—Pt—Ir), Ta—Ru, and Nb—Ru. Examples of advanced structural metal include but are not limited to high entropy alloys, nanostructured metals, nanostructured alloys, metallic glasses, bulk metallic glasses, superalloys, hot stamped steels, martensitic steels, and ultrahigh strength metals. In some implementations, the flyer plate can comprise a sheet. In other implementations, the flyer plate is a wire, a group of wires previously welded together, or any other possible shape or configuration.

The target sheet 310 can be, for example, a sheet of nitinol. In some implementations, the target plate can comprise a shape memory alloy, a pseudoelastic alloy, a nickel alloy, a radio-opaque alloy, an advanced structural metal, a refractory metal, a refractory alloy, stainless steels, a titanium alloy, an aluminum alloy, or an amorphous metal. Possible shape memory alloys include but are not limited to nickel-titanium shape memory alloys, such as a nickel-titanium-iron (Ni—Ti—Fe) alloy, a nickel-titanium-copper (Ni—Ti—Cu) alloy, a nickel-titanium-lead (Ni—Ti—Pb) alloy, or a nickel-titanium-hafnium (Ni—Ti—Hf) alloy, Ni—Ti—Pd, Ni—Ti—Hf—Zr, NiTi—Zr, or NiTi—Er. Other possible shape memory alloys include, but are not limited to copper-aluminum SMAs (e.g., Cu—Al—Ni, Cu—Al—Nb), cobalt-based SMAs (Co—Al, Co—Ni—Al), nickel-aluminum SMAs (Ni—Al), nickel-manganese SMAs (Ni—Mn, Ni—Mn—Ga), Zr—Cu, U—Nb, titanium-based SMAs (Ti—Nb, Ti—Pd, Ti—Au, Ti—Pt—Ir), Ta—Ru, and Nb—Ru. Examples of advanced structural metal include but are not limited to high entropy alloys, nanostructured metals, nanostructured alloys, metallic glasses, bulk metallic glasses, superalloys, hot stamped steels, martensitic steels, and ultrahigh strength metals. In some implementations, the target plate can comprise a sheet.

The high power pulsed laser 302 is capable of depositing from 0.1 to 100 Joules of optical energy focused in a local area on the top surface of flyer plate tab 308a in the range of 5 ns and 500 ns and with a power density less than or equal to 100 GW/cm². The energy focused on the flyer plate tab 308a is accelerated by the interaction of the incident laser beam 304 and the top surface of the flyer plate 308, causing the flyer plate tab 308a to impact target sheet 310 at a velocity in the range of 300 m/s to 1000 m/s to thereby develop a metallurgical bond upon impact.

In some embodiments, the metallurgical bond can have a surface area of at least 50 nm² (e.g., at least 100 nm², at least 250 nm², at least 500 nm², at least 750 nm², at least 1 μm², at least 10 μm², at least 50 μm², at least 100 μm², at least 250 μm², at least 500 μm², at least 750 μm², at least 1 mm², at least 10 mm², or at least 50 mm²). In some embodiments, the metallurgical bond can have a surface area of 100 mm² or less (e.g., 50 mm² or less, 10 mm² or less, 1 mm² or less, 750 μm² or less, 500 μm² or less, 250 μm² or less, 100 μm² or less, 50 μm² or less, 10 μm² or less, 1 μm² or less, 750 nm² or less, 500 nm² or less, 250 nm² or less, or 100 nm² or less).

The metallurgical bond can have a surface area ranging from any of the minimum values described above to any of the maximum values described above. For example, in some embodiments, the metallurgical bond can have a surface area of from 50 nm² to 100 mm². In some implementations, the metallurgical bond may have a surface area on the order of square nanometers or square micrometers (e.g., from 50 nm² to 1 μm², or from 1 μm² to 1 mm²).

The system 300 is augmented by placing a tamping, absorptive, and/or ablative layer 316 on the top surface of the flyer plate tab 308a and/or by placing a transparent backing 306 so as to allow it to react against the expanding gas caused by ablation emanating from the top surface of the flyer plate tab 308a.

The ablative layer 316 may be formed from a variety of materials that efficiently ablate when struck with laser beam 304. In some implementations, the ablative layer is a carbonaceous material, cellulosic material (e.g., a cellophane-type material), nitromethane-based material, azide-based material, oxidizer-oxidant material, nanopowder material, any material with a rapid exothermic reaction, or any combination thereof. In some implementations, the ablative layer is shaped (i.e., increasing in thickness in one direction, having a pyramidal shape, etc.) or provides as a film having a near constant thickness.

In some implementations, the system further includes a tamping layer that includes flowing water (e.g., de-ionized water) over the flyer plate 308 such that the water forms the tamping layer.

The transparent backing 306 may be formed of any material through which the laser beam 304 may pass without significant loss in optical energy in order to provide sufficient velocity so as to weld the flyer plate tab 308 to target sheet 310. In some implementations, the transparent backing includes sapphire, quartz, glasses, polymers or any combination thereof.

In some implementations, acceleration is also done with some other energy source such as focused non-coherent light or by VFAW. In some implementations, the flyer plate tab is bent away from an otherwise planar member as the surface that is being accelerated into a bond-forming collision with another member. In some implementations, the flyer plate is intermixed with the target sheet. It will be clear to one of skill in this art that the requisite features for practice of the concept described herein are an energy source that can generate the requisite amount of acceleration by impacting the surface and a gap between the members being joined.

The distance between the flyer plate tab 308a and the target sheet 311 ranges from 0.1 mm to 1 cm or any distance that is sufficiently large to allow the acceleration to occur, but, at the same instant, be sufficiently small to efficiently limit the power needed to effect the acceleration.

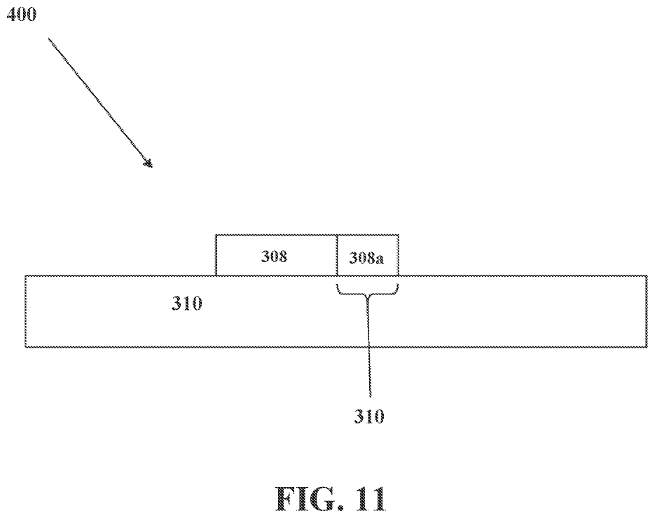

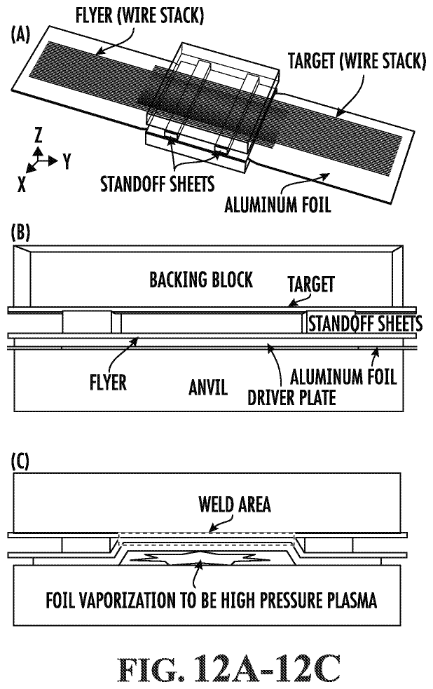

FIG. 11 illustrates the article 400 produced by welding the flyer plate tab 308a of flyer plate 308 to the target sheet 310. A metallurgical bond 402 exists between the flyer plate tab 308a and target sheet 310. The metallurgical bond 402 exists between the stainless steel flyer plate 308 and the nitinol target sheet 310. Furthermore, in some implementations, LIW creates welds between dissimilar metal such as nitinol-stainless steel, nitinol-nitinol, aluminum-steel and magnesium-aluminum.

In some implementations, the target sheet includes a casting and the flyer plate includes a shape memory alloy.

A variety of devices benefit from the use of the aforementioned methods for joining shape memory alloys. The devices produced using either or both of the aforementioned methods include welds that have over a 63% joint efficiency based on the ultimate tensile strength of the shape memory alloy, substantially no brittle intermetallics, and substantially no heat affected zones (HAZ). The devices include a weld joining a first metal and a second metal. The first metal, second metal, or a combination thereof including a shape memory alloy. In some implementations, the devices produced from the joining of a shape memory alloy to itself, a dissimilar metal, or a similar metal. In some implementations, the first metal and/or the second metal is a sheet of a shape memory alloy, a pseudoelastic alloy, a nickel alloy, a radio-opaque alloy, an advanced structural metal, a refractory metal, a refractory alloy, stainless steels, a titanium alloy, an aluminum alloy, or an amorphous metal. Possible shape memory alloys include but are not limited to nickel-titanium shape memory alloys, such as a nickel-titanium-iron (Ni—Ti—Fe) alloy, a nickel-titanium-copper (Ni—Ti—Cu) alloy, a nickel-titanium-lead (Ni—Ti—Pb) alloy, or a nickel-titanium-hafnium (Ni—Ti—Hf) alloy, Ni—Ti—Pd, Ni—Ti—Hf—Zr, NiTi—Zr, or NiTi—Er. Other possible shape memory alloys include, but are not limited to copper-aluminum SMAs (e.g., Cu—Al—Ni, Cu—Al—Nb), cobalt-based SMAs (Co—Al, Co—Ni—Al), nickel-aluminum SMAs (Ni—Al), nickel-manganese SMAs (Ni—Mn, Ni—Mn—Ga), Zr—Cu, U—Nb, titanium-based SMAs (Ti—Nb, Ti—Pd, Ti—Au, Ti—Pt—Ir), Ta—Ru, and Nb—Ru. Examples of advanced structural metal include but are not limited to high entropy alloys, nanostructured metals, nanostructured alloys, metallic glasses, bulk metallic glasses, superalloys, hot stamped steels, martensitic steels, and ultrahigh strength metals. In some implementations the weld of the device is a single wire weld, a plurality of wire welds, a lap weld, a scarf weld, a ring/sleeve weld, a plug weld, or an additive flyer weld. Furthermore, such devices produced from the aforementioned methods are medical devices, compliant devices, locking devices, sensing devices, micro-electro-mechanical devices, actuators, tubes, or wires with similar or dissimilar metal ends.

Examples of medical devices include the entire spectrum of articles adapted for medical use, including scalpels, needles, scissors and other surgical tools used in invasive surgical, therapeutic or diagnostic procedures; implantable medical devices, including artificial blood vessels, guidewires, stents, catheters and other devices for the removal or delivery of fluids to patients, artificial hearts, artificial kidneys, orthopedic pins, plates and implants; catheters and other tubes (including urological and biliary tubes, endotracheal tubes, peripherably insertable central venous catheters, dialysis catheters, long term tunneled central venous catheters, peripheral venous catheters, short term central venous catheters, arterial catheters, pulmonary catheters, Swan-Ganz catheters, urinary catheters, peritoneal catheters), urinary devices (including long term urinary devices, tissue bonding urinary devices, artificial urinary sphincters, urinary dilators), shunts (including ventricular or arterio-venous shunts); prostheses (including breast implants, penile prostheses, vascular grafting prostheses, heart valves, artificial joints, artificial larynxes, otological implants), vascular catheter ports, wound drain tubes, hydrocephalus shunts, pacemakers and implantable defibrillators, and the like.

By way of non-limiting illustration, examples of certain embodiments of the present disclosure are given below.

### Examples

General Methods

Joint efficiency is defined as the ratio of the strength of the joint, as measured in force to failure, divided by the strength of the weaker of the two elements of the joining pair in the mode of loading that is relevant to an application. Joint efficiency can be readily evaluated using mechanical tests to determine the failure loads of the joint and base materials. The joint efficiency is calculated as the failure load of the joint divided by the failure load of the weaker base metal. Generally, joint efficiencies scale between 0 and 100%.

The heat affected zone (HAZ) is the non-melted region bordering the weld, which has undergone changes in material properties as a result of being exposed to high temperatures. Joints can be evaluated for the presence of heat affected zones by measuring microhardness or nanohardness in a cross section of a weld interface (e.g., across the unaffected base material, HAZ, and weld). Heat affected zones have a hardness that is changed (usually depressed) in a statistically-significant way relative to the basis material. Microscopy methods including optical, scanning electron, and transmission electron can also be used to detect changes in the microstructure across these regions. Finally changes in the microstructure could also be detected by methods such as x-ray diffraction. In the case of VFAW or LIW, heat affected zones are dramatically narrower than those from fusion welds (e.g., less than 50 μm, less than 25 μm, less than 20 μm, less than 15 μm, less than 10 μm, less than 5 μm, or less than 1 μm). Such joints can be said to be substantially free of heat affected zones.

Intermetallics can be identified by standard cross-sectional metallography. Intermetallics tend to become brittle if continuous and thicker than about 10 μm. In the case of VFAW or LIW, intermetallics, if present, are dramatically thinner than those from fusion welds (e.g., usually less than 10 μm, less than 5 μm, or less than 1 μm; and they are usually discontinuous). Such joints can be said to be substantially free of brittle intermetallics. Detection of these phases can be completed using a variety of techniques. Micro-hardness measurements may provide indication of their presence but often need to be coupled with other techniques such as phase analysis by x-ray diffraction, selected area diffraction with transmission electron microscopy, or elemental analysis with scanning electron microscopy and energy-dispersive x-ray spectroscopy, or electron energy loss spectroscopy with transmission electron microscopy.

### Example 1. Methods of Joining NiTi to NiTi and Stainless Steel Using VFAW

Experimental Design

0.5 mm square NiTi wires and 304 V SS wires, provided by Fort Wayne Metals, were selected as the experimental materials. A Magneform capacitor bank with maximum charging energy of 16 kJ and a current rise time of 9 μs was used as the power source. The input energy used in this work is 12 kJ for all samples. A 0.05 mm thick spot-type aluminum foil was used as the actuator. This type of foil under an input energy of 12 kJ will generate an impact speed of 500 to 600 m/s. The flyer and the target are formed by combining 30 wires with length of 80 mm. The standoff distance is 3.2 mm, and the standoff separation distance is 20 mm. As shown in FIG. 11, when a high current, near 100 kA, goes rapidly heats this aluminum foil, the narrowest active region will vaporize and create a high-pressure plasma. In this example, a stainless steel (SS) driver plate was used to transmit the pressure created by the vaporized aluminum foil to NiTi wire flyer and push forward these wires to collide with the target wires, as shown in FIG. 11c. While the SS driver plate will be deformed along with the flyer, no welding will occur between the flyer and the driver plate because a thin polymer layer separates them. Once these wires are accurately aligned, those parallelly positioned at the same location in the X direction will be welded. This method is therefore able to obtain multiple nitinol wire welds at one shot which greatly improves the welding efficiency.

The interfacial microstructures of the NiTi/NiTi welds and NiTi/SS welds were examined through optical microscopy (OM) and scanning electron microscopy (SEM). The elemental distributions were measured by Energy-dispersive X-ray spectroscopy (EDS). The phase transformation characteristics of the NiTi base metal, NiTi/NiTi welds, and NiTi/SS welds were measured by differential scanning calorimetry (DSC) using a DSC2500 calorimeter made by TA instruments. DSC tests were conducted at temperatures ranging from −80 to 120° C. with a controlled heating/cooling rate of 10° C./min under an Argon atmosphere following the ASTM F2004-17 standard. All samples for DSC tests were prepared with a dimension of 1 mm by 0.5 mm by 1 mm and a weight of 10 to 12 mg. Microhardness tests were performed with a square-based pyramid diamond indenter operating at a load of 200 g and a dwell time of 5s. The cycling tests were performed with displacement control (0 to 2 mm to 0) under a crosshead displacement rate of 0.04 mm. min-1. mm-1 based on ASTM F2516-18 standard. The gauge length of the tested specimens is 50 mm so that the displacement rate is 2 mm/min and the cycling strain is 4% for all samples. A limited number of 100 cycles were performed on all the samples. Lap shear tests were conducted on an MTS EM Test Frame with a displacement rate of 2 mm/min for NiTi base metal, SS base metal, NiTi/NiTi welds and NiTi/SS welds. Three replicates for each type of samples.

Results

1.1. Microstructure Characterization

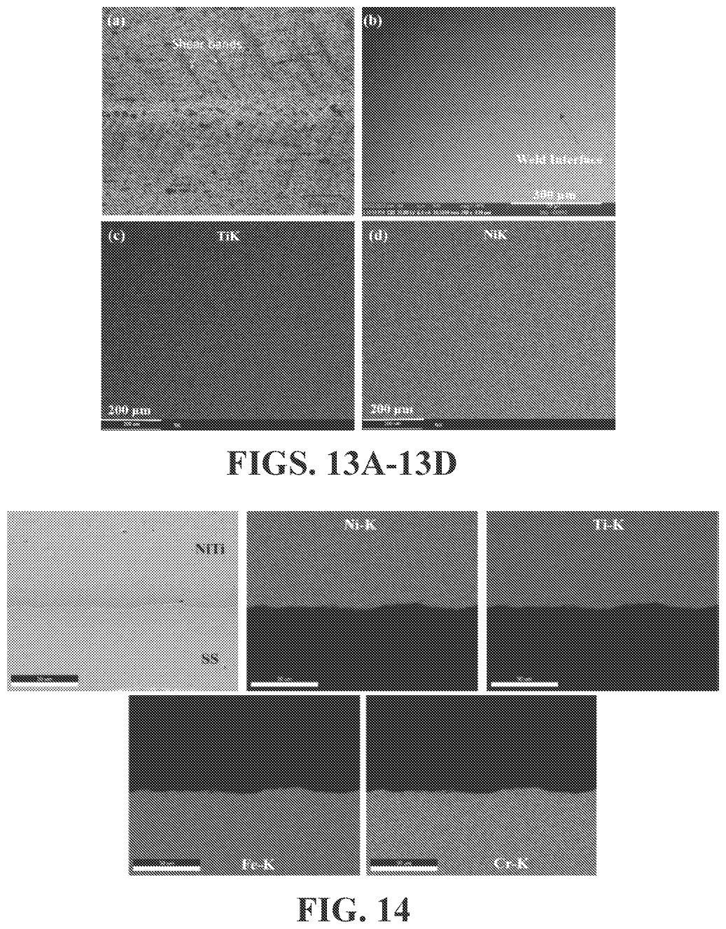

The weld interfaces of a typical NiTi/NiTi weld and a NiTi/SS weld were studied in FIGS. 13 and 14, respectively. Wavy interface is characteristic of high velocity impact welding, which was observed in both types of welds. As shown in FIG. 13a, shear bands are symmetrically distributed along the interface of NiTi/NiTi welds and indicate a thermomechanical instability. Some black dots shown near the interface are the remnants of etchants, while oxides or carbides are exhibited at the far side of the interface.

No elemental segregation as may take place during solidification or selective volatilization was observed in either the similar or dissimilar welds. BSE-SEM image in FIG. 13b of the NiTi/NiTi weld can barely show contrast at the weld interface, which was confirmed by the EDS maps of Ti and Ni. The EDS maps exhibited homogeneous distributions of Ni and Ti through the whole examined area. This homogeneous elemental distribution was also observed in the NiTi/SS weld interface, as shown in FIG. 14. The elemental distributions of Ni, Ti, Fe, and Cr, the major elements of NiTi and SS, show a sharp transition across the NiTi/SS interface. Solid-state and homogeneous weld interfaces indicate strong bonding, resulting in superior mechanical and functional property tests which will be studied in the following sections.

1.2. Phase Transformation Characteristics

Phase transformation temperatures have been good indicators for the functional properties of nitinol welds. After impact welding, these temperatures can be expected to change due to the severe plastic deformation involved in the welding process. Phase transformation temperatures such as Ms, Mf, Rs, Rf, As and Af were determined through the intersection of the baseline with the line of maximum inclination of the transformation peaks based on the ASTM F2004-17 standard. However, due to the small joining area in VFAW welds, DSC samples for NiTi/NiTi and NiTi/SS welds retained certain amounts of NiTi and SS base metal. This will influence the DSC results due to the overlapping effect.

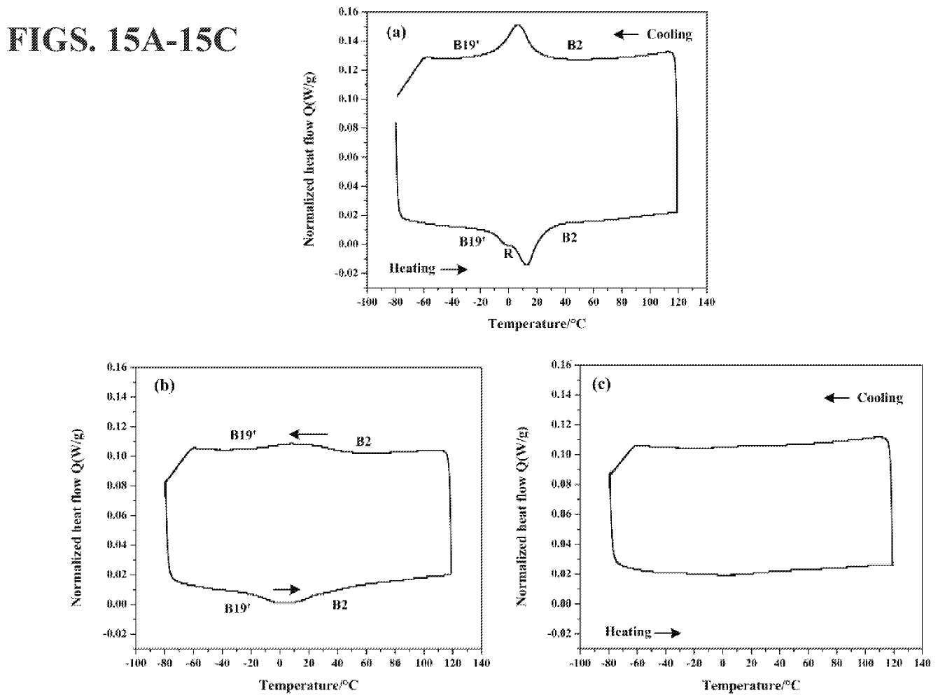

FIG. 15 shows that one-step B2→B19′ transformation was observed in the cooling stage for NiTi base metal, while in the heating stage a B19′ →R→B2 two step transition was observed. Rf and As could not be determined due to the flat stage for R phase transformation. After VFAW, the NiTi/NiTi welds exhibited a one-step reversible B2-B19′ phase transformation. Table 1 shows that the NiTi/NiTi weld exhibited a widened transformational temperature range compared to the NiTi base metal. Plastic deformation is known to broaden the transformation temperature range and reduce the magnitude of the transformation peaks due to the increased barrier to transformation. The plastic deformation can also make transformation impossible due to the restriction of the microstructure. No heat flow peaks were observed in the NiTi/SS welds. The inactive SS side of the weld may further impeded transformation compared to the NiTi/NiTi weld.

Table 1. Transformation temperatures (° C.) of the NiTi base metal, the NiTi/NiTi weld, and the NiTi/SS weld where As and Af indicate the austenite start and finish temperatures, respectively; Rs and Rf indicate the R phase start and finish temperatures, respectively; Ms and M f indicate the martensite start and finish temperatures, respectively.

| Materials | As | Af | Rs | Rf | Ms | Mf |
|---|---|---|---|---|---|---|
| NiTi base metal | — | 26.4 | −15.3 | — | 22 | −12 |
| NiTi/NiTi weld | −34.6 | 54.5 | — | — | 55 | −19.6 |
| NiTi/SS weld | — | — | — | — | — | — |

1.3. Mechanical Properties

1.3.1. Microhardness Measurement

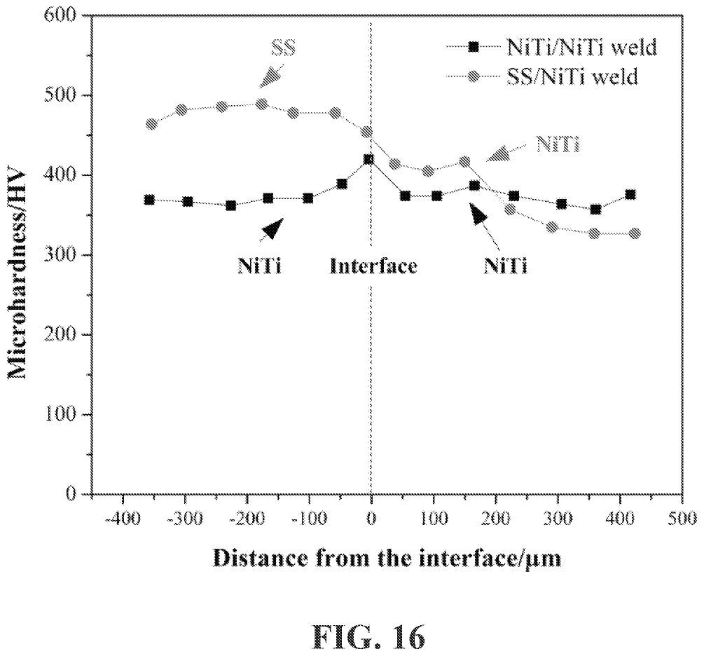

The severe plastic deformation involved in the VFAW process could induce grain refinement near the weld interface, which increases the hardness in the adjoining regions. FIG. 16 shows the hardness distributions across the interfaces of NiTi/NiTi and NiTi/SS welds. The general trend of hardness distributions is useful to examine the mechanical behavior of nitinol base metal and welds.

For NiTi/NiTi welds, the interface gained a slight hardening compared to the NiTi base metal. For NiTi/SS welds, the NiTi side exhibits the same hardening effect, and the interface near the SS side shows comparable hardness to the SS base metal. These hardness distributions show that no heat affected zones were formed in the VFAW nitinol welds. This phenomenon has also been observed in explosive welding of nitinol to steel and VFAW of other metal combinations such as Al/Fe and Ti/SS. This lack of HAZ formation and the strengthened weld interfaces contribute to the superior mechanical and functional properties compared to other traditional fusion-based and solid-state welding technologies which normally involve structural coarsening and softening.

1.3.2. Lap Shear Tests

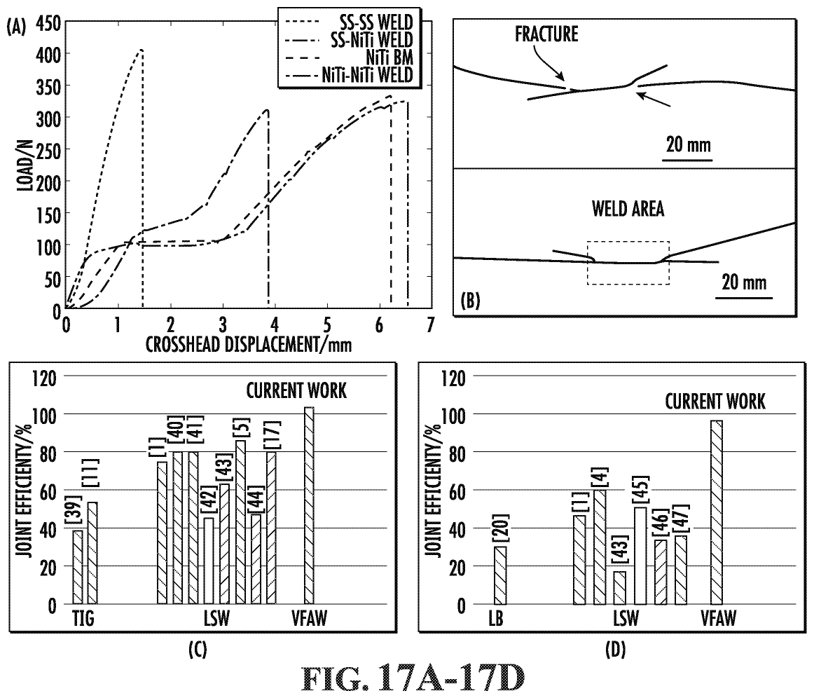

Lap shear tests were conducted to measure the macro mechanical properties of similar and dissimilar nitinol welds. FIG. 17a compares the lap shear testing results among NiTi base metal, and SS-SS weld, NiTi/NiTi weld and NiTi/SS weld. It was seen that NiTi/NiTi weld possesses very similar load-displacement curve as the NiTi base metal, that is, similar elastic response, similar stress induced martensite plateau, and similar elastic/plastic deformation of martensite to failure. NiTi/SS weld exhibited a load-displacement curve somewhere between those of NiTi/NiTi weld and SS-SS weld. The load plateau of NiTi/SS weld is narrower and more inclined compared to that in NiTi/NiTi weld due to half of the gauge length being SS, which plastically deformed. In this work, the elongation rates for NiTi base metal and nitinol welds are not directly related and cannot be compared due to the lap-type joint configurations for NiTi/NiTi and NiTi/SS welds. The peak load for NiTi base metal is used as a reference to calculate the joint efficiencies for NiTi/NiTi and NiTi/SS welds.

The joint efficiencies of NiTi/NiTi and NiTi/SS welds made by different welding methods were compared in FIGS. 17c and 17d. For similar welding of NiTi to itself, the joint efficiencies of TIG welds are around 38 to 60%. NiTi/NiTi laser welds entail relatively higher efficiencies ranging from 40 to 86%, while both TIG and laser welds present lower joint efficiencies compared to NiTi/NiTi welds made by VFAW (100%). For dissimilar welding of NiTi to SS, the joint efficiencies for welds made by other traditional methods such as laser brazing and laser welding range from 15 to 60%, which are much lower than those in VFAW (96.3%). Both NiTi/NiTi and NiTi/SS welds fractured at the NiTi base metal after lap shear testing which further confirms that the welds are stronger than the base metal, as shown in FIG. 17b. This shows the superior mechanical properties that VFAW can achieve in dissimilar welding of NiTi to SS compared to other traditional welding technologies. This is due to the solid-state welding interface, the lack of HAZ formation and the interfacial hardening as studied in Sections 1.1 and 1.3.1.

1.3.3. Cycling Tests

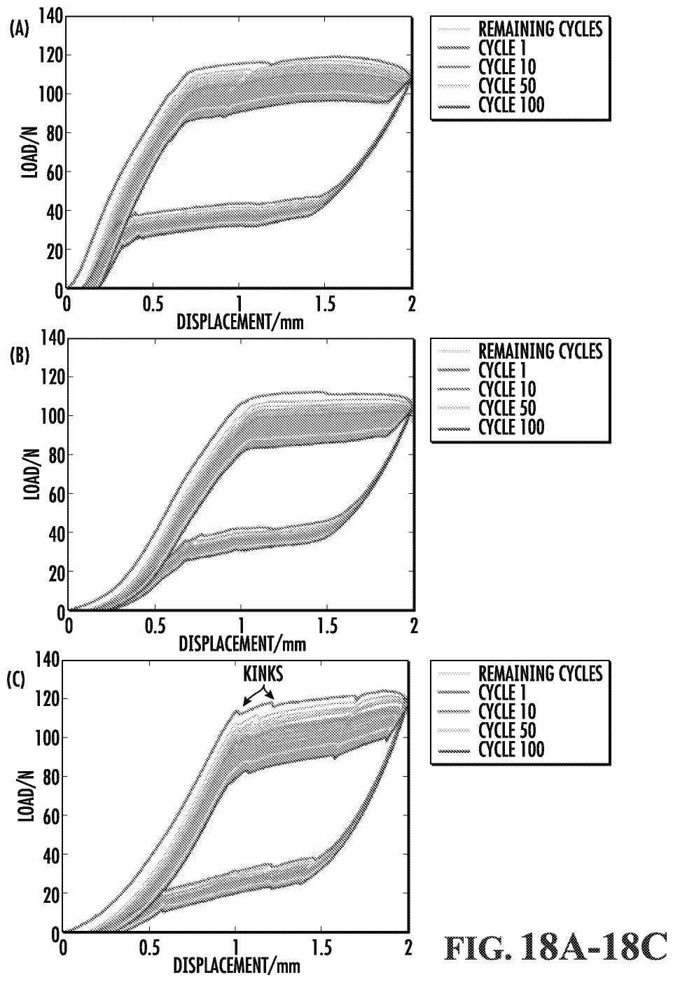

To determine the superealstic behavior and its repeatability of the similar and dissimilar nitinol welds, 100 stress-strain cycles were conducted on the NiTi base metal, NiTi/NiTi welds, and NiTi/SS welds. The results in FIG. 7 show that both NiTi/NiTi and NiTi/SS welds present very similar pseudoelasticity curves as the NiTi base metals. Specifically, they exhibited similar stress induced martensite (SIM) plateaus, and the SIM load plateau value decreases and then stabilizes as the cycle number increases. This might be due to the dislocation build-up and the stored strain enabling easier transformation in the successive cycles. The irrecoverable strains for NiTi/NiTi and NiTi/SS welds are less than 0.5% and 0.68%, respectively, which are comparable to that in the NiTi base metal (0.37%). It is worth mentioning that NiTi/SS welds show a slightly slower stabilization due to the plastic deformation of stainless steel. The curves are also twisted due to the asymmetry of transformation (only one half of the assembly is transforming). After 100 cycles, these welds did not fracture. When these cycling tested welds are strained to fracture, they still retained around 80 to 85% of the UTS of the NiTi base metal (not shown in FIG. 18).

### Example 2. Further Investigations of VFAW for Joining Shape Memory Alloys

Experimental Design

2.1 Vaporizing Foil Actuator Welding Process

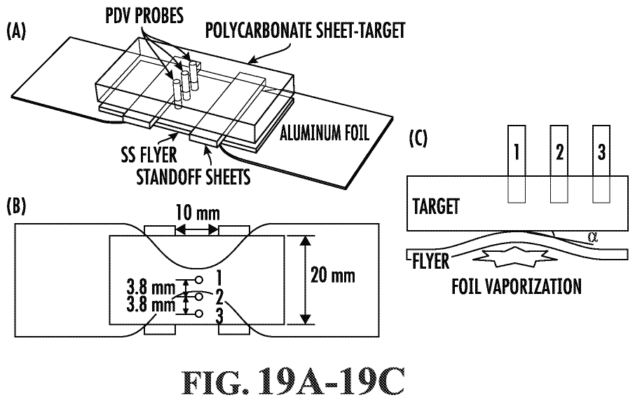

In this work, 436 ferritic stainless steel (Fe-16Cr-1Mo-1Mn-0.5Nb-0.12C), with a thickness of 0.3 mm was chosen as the flyer. A 0.37 mm thick near equiatomic NiTi SMA with nominal compositions of 55.8 wt. % (50.7 at. %) Ni and 44.2 wt. % (49.3 at. %) Ti was selected as the target. Before welding, these NiTi SMA sheets were heat treated at 1000° C. for one hour in glass tubing filled with 0.2 atm of argon gas and furnace cooled to room temperature. This annealing treatment helped remove the residual cold work due to processing issues of NiTi base metals. The electrical storage and discharge source used in this work was a Maxwell Magneform capacitor bank with a maximum charging energy of 16 kJ, total capacitance of 426 g, inductance of 100 nH, and a rise time of 12 μs. The VFA patch welding process was introduced in a previous work. As shown in FIG. 19, a 0.002″ thick spot-type aluminum foil, placed beneath and insulated from the SS flyer, was vaporized with an input energy of 4 kJ. The high-pressure plasma generated from the foil vaporization accelerates the flyer to a high speed, usually from 300 to 1000 m/s, and impacts with the target sheets to form a collision weld. FIG. 1 illustrates the experimental configuration.

Standoff sheets with thickness of 0.8 mm and span distance of 10 mm between supports were used to provide the acceleration distance and impact angle suitable for achieving collision welds. Three-channel Photon Doppler Velocimetry (PDV) were used to measure the impact velocity and collision angle at three locations with interval of 3.8 mm from the weld center to edge, as shown in FIGS. 19a and 19b. During the process of measuring flyer velocity traces, a 9 mm thick transparent polycarbonate sheet was used as a target sheet to simulate the impact between SS to NiTi in addition to providing lines of sight for PDV channels. The impact angles, shown in FIG. 19c, were calculated through the ratio of the difference in flyer travel distance between different channels to probe separation distance. This ‘patch’ weld geometry proven to be robust and an excellent basis to understand the characteristics of a given bonding pair.

2.2. Microstructure Characterization and Mechanical Testing Methods

The NiTi/SS impact spot welds were cross-sectioned, mounted and then ground with sandpaper sequentially from 240 to 1200 fin. grits. The samples were further polished from 6 to 1 μm using microid diamond compound to obtain a proper surface finish for microstructure characterization. The interfacial microstructures of NiTi/SS impact welds were studied through optical microscopy (OM), scanning electron microscopy (SEM), and transmission electron microscopy (TEM). Dual beam Focused Ion Beam (FIB) technique were used to obtain the TEM foil lifted out from a wavy interface that shows a nearly discontinuous change across the flyer and target. TEM observations were conducted on a Tecnai F20 with an accelerating voltage of 200 kV. Selective Area Diffraction (SAD) patterns were obtained across the interface between NiTi and SS. Chemical compositions of molten regions and interdiffusion between NiTi and SS were characterized by energy-dispersive Xray spectroscopy (EDS) with probe size of 1 nm. The phase transformation characteristics of the NiTi base metal and NiTi/SS welds were measured by differential scanning calorimetry (DSC) using a DSC2500 calorimeter made by TA instruments. DSC tests were conducted at temperatures ranging from −80 to 120° C. with a controlled heating/cooling rate of 10° C./min following the ASTM F2004-17 standard. Microhardness tests were done with a square-based pyramid diamond indenter operating at a load of 200 g and a dwell time of 5 s to measure the hardness distributions across the interfaces. Lap shear samples were created between SS sheets (20 mm by 70 mm by 0.3 mm) and NiTi sheets (13.7 mm by 6 mm by 0.37 mm). Three samples for each case were lap shear tested in a MTS EM Test Frame with a crosshead displacement rate of 1 mm/min. The two base metals were also tensile tested in the same MTS frame with the same displacement rate.

Results

3.1. Welding Process Characteristics

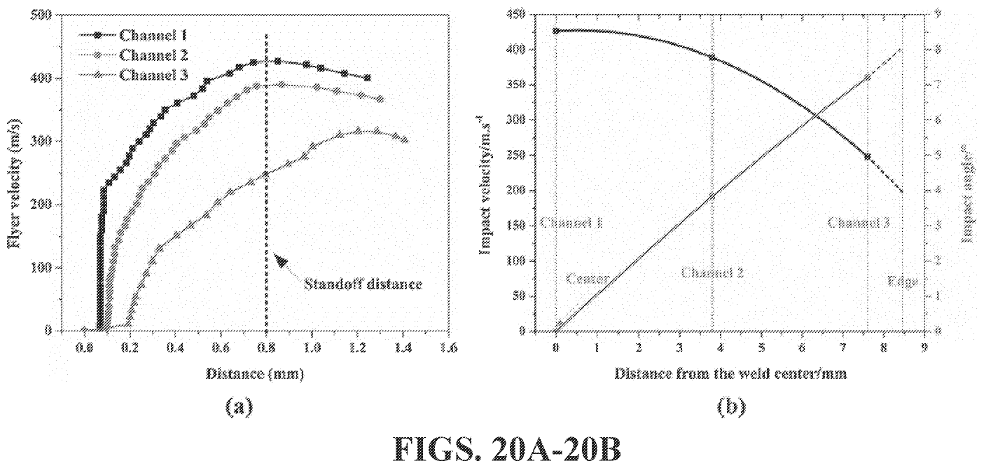

Impact velocity and impact angle are the primary parameters in understanding the impact welding process and microstructure evolution along the interface. The flyer velocity versus time traces for three channels are shown in FIG. 20a, and from these data, the evolution of impact velocity and impact angle from the weld center to the edge are estimated and shown in FIG. 20b. Note that the flyer velocity at the standoff distance is defined as the impact velocity which is the normal speed at impact. Flyer velocity traces at the weld center (Channel 1) and at 3.8 mm intervals towards the edge (Channels 2 and 3) are shown in FIG. 20. This allows the estimation of collision speed and angle over the welded zone. FIG. 20b shows that impact velocity ranges from 440 to 200 m/s from the center to edge, and the corresponding impact angle ranges from 0 to 8°. The decrease of impact velocity and increase of impact angle from the center to edge is primarily responsible for the variation of interfacial microstructure, which will be examined in the following sections.

3.2.1. Macrostructure and Microstructure

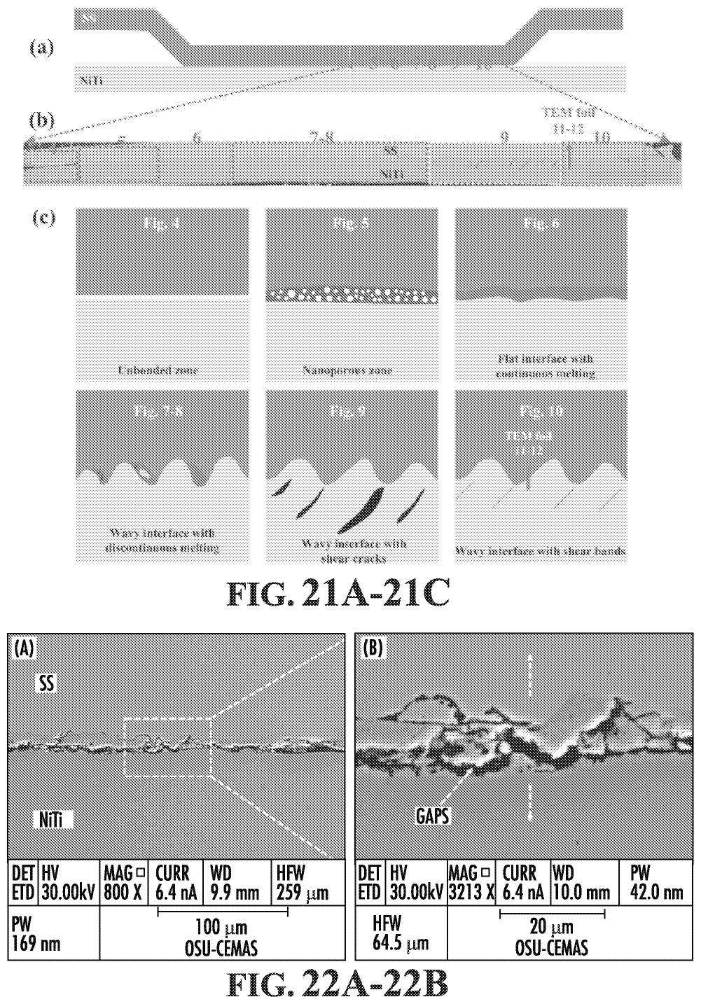

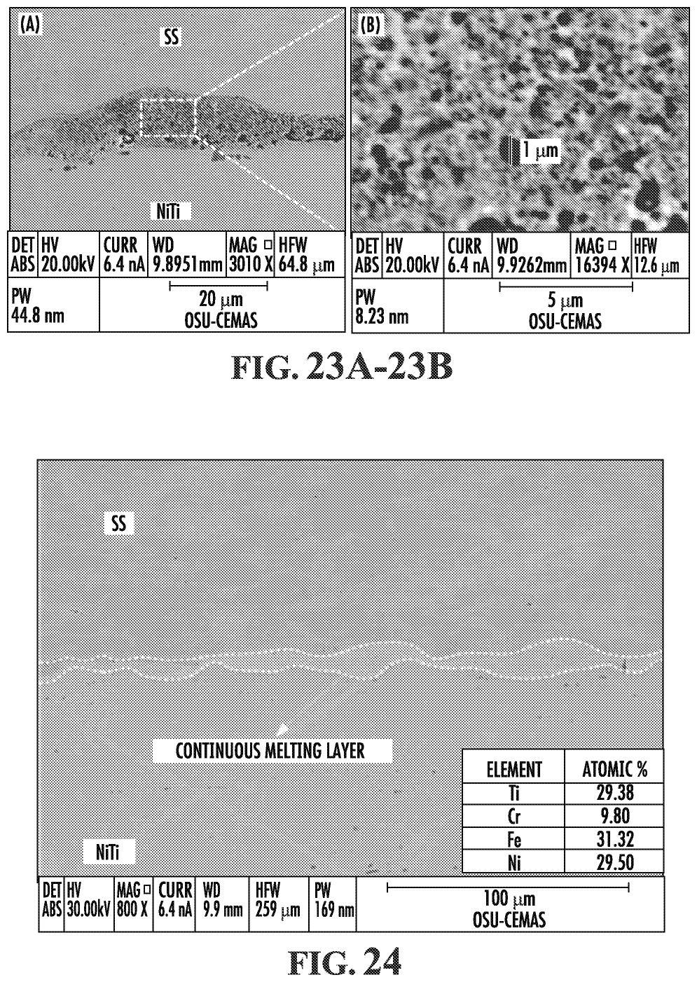

The evolution of impact velocity and impact angle along the interface, shown in FIG. 20, led to spatially varying microstructures, as is illustrated at a high level in FIG. 21. There is an unboned zone at the center, moving outward this is sequentially followed by a nanoporous zone, a flat interface with continuous melting, a wavy interface with discontinuous melting, a wavy interface with shear cracks and a wavy interface with shear bands. Each zone will be discussed in turn and associated detailed figure numbers are shown in FIG. 21. The local structure is most directly related to impact angle and impact velocity. The waviness of the weld interface increases, and the melting is reduced from the center to the corner as the collision angle increases and impact velocity decreases. An unboned zone in the weld center, shown in FIG. 22, is typical in patch welding geometries. This region was formed since the impact in the weld center is normal to the interface. This region has the highest impact speed. This results in excessive heat generation from impact to melt the interface, which is then split apart due to rebound. As is shown later, this unbonded zone does not adversely affect the overall mechanical strength of weld, as is common in other systems. A nanoscale porous zone was formed near the unbonded zone (FIG. 23). Multiple studies of impact welding have shown that the greatest heat input is associated with high impact speed and low collision angle. This nanoporous zone likely underwent rapid heating and melting with some vaporization, and the porosity is the result of metallic boiling and quenching. Similar structures have been observed in magnetic pulse welding. These pores with diameters ranging from 100 nm to 1 μm are highly dispersed and randomly dispersed.

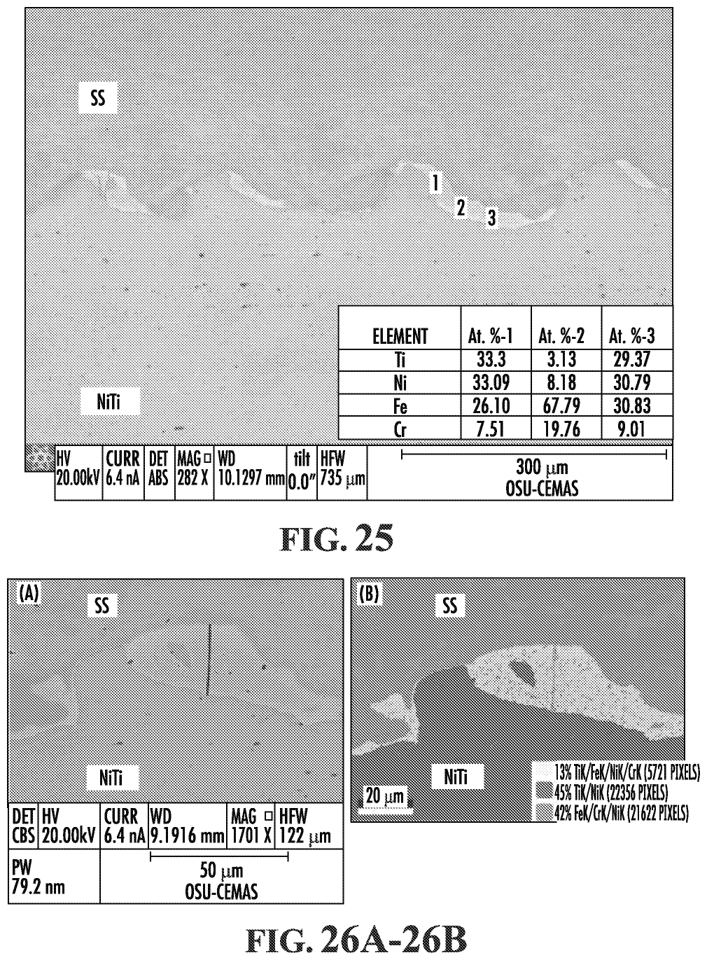

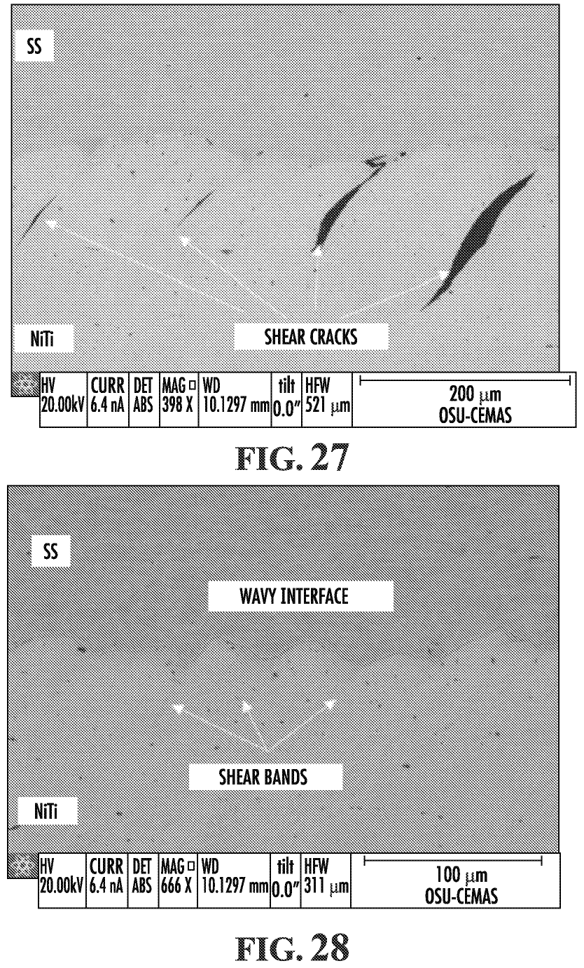

Moving further outward from the nanoporous zone, the impact velocity decreases, and the impact angle decreases. This leads to the formation of a flat interface with continuous melting as shown in FIG. 24. The structure can be complex with melting and mixing of the materials on both sides of the interface, being most important, backscatter contrast indicates compositional variation that can be caused by fracturing of small chunks of material from each side and some solid-state diffusion. The interface presents slight waviness. EDS mapping analyses show the atomic composition as about 29.38% Ti, 9.8% Cr, 31.32% Fe and 29.5% Ni, which shows good mixing of both components. Intermetallics such as (Fe, Cr)Ti and Ni—Ti phases (Ti2Ni and Ni3Ti) likely were formed in this region. It is also possible that this area is amorphous as it has 5 principal elements and saw a very high cooling rate. Structure of these regions will be the subject of future studies. Wavy interface with discontinuously distributed melting pockets along the interface was shown in FIGS. 25 and 26. EDS again shows an intermediate chemistry between the flyer and target in the molten and resolidified regions. Microcracks also form nearly perpendicular to the interface this can be due to intermetallic or amorphous phase formation. Some NiTi fragments are observed in the molten zones (FIG. 26). These can be jetted off the interface during the process. It is significant that any mixed resolidified regions are isolated and discontinuous. The isolation of the solidified regions with well-bonded regions in between gives good promise for mechanical strength and toughness. Following the wavy interface with discontinuous melting, a wavy interface with no melting but with shear cracks and slight shear banding was formed and shown in FIG. 27. These shear cracks are parallel to each other and formed between about 45° to 60° inclination to the interface along the shear banding direction. The spacing distance and length of shear cracks are variable. The spacing distance is between 100-200 μm and the length varies from 50 to 200 μm. These cracks are likely due to adiabatic shear banding to the point of local melting which causes separation or cracking. Again, these will be subject to future study.

Further along the interface, the shear cracks disappear, good bonding is apparent, and some shear banding is also shown (FIG. 28). This interface has no melting or cracks and may be considered an ideal weld interface. The shear band spacing is between 50-100 μm and the length varies from 30 to 100 μm. The adiabatic shear bands show an approximate 60° inclination to the interface which implies the failure mechanisms that occurs in metals deformed at a high strain rate in high velocity impact welding. The heat produced during plastic deformation is potentially retained in these shear banding zones.

Adiabatic shear banding and cracking have been seen before in high speed impact and welding. The reasons for the formation of shear banding could be ascribed to the localized plastic instability resulting from the sudden increase of temperature and thermal softening. In this work, no adiabatic shear bands or shear cracks were found in the SS side presumably because thermal softening required for shear banding is not as severe in the stainless steel, or is balanced by strain rate sensitivity.

3.2.2. TEM Analyses of the NiTi/SS Interface

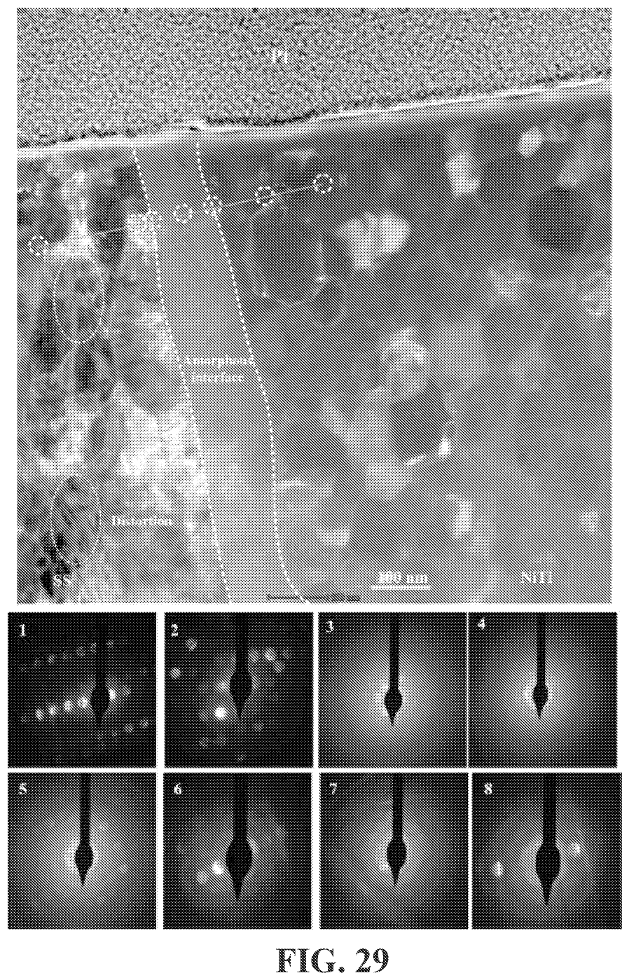

In one particularly narrow (or discontinuous-appearing NiTi-SS interface as exemplified in FIG. 28) a TEM foil was lifted out and studied. This region had a wavy interface with no melting and no shear cracks, as shown in FIG. 21. This foil shows complex short-length-scale heterogeneity along the length and width direction of the interface. Focused Ion beam etching allowed a sample to be removed and a line Select Area Diffraction (SAD) analysis of the NiTi-SS interface is shown in FIG. 29.

The results show that amorphization occurred at the NiTi-SS interface and over some region of the NiTi side, being particularly correlated with grain boundaries. The width of the amorphous-including layer is at least 100 nm. The grains in the NiTi side, with grain sizes ranging from 20 to 100 nm, are more equiaxed compared to those elongated and deformed grains found in the SS side. On the SS side, the structure is clearly crystalline, with fine grains and distortion. The mixed zone between the two materials is about 100 nm thick and diffraction indicates that region is amorphous. This is likely due to the formation of a multi-component melt and rapid solidification, as discussed later.

Moving into the NiTi side, SAD patterns 5-8 suggest a mixture of amorphous and crystalline structures. This is also not fully surprising as near-equiatomic NiTi structures have been observed to collapse into amorphous zones at high levels of plastic strain. These amorphous zones seem to be particularly associated with grain boundaries and triple points.

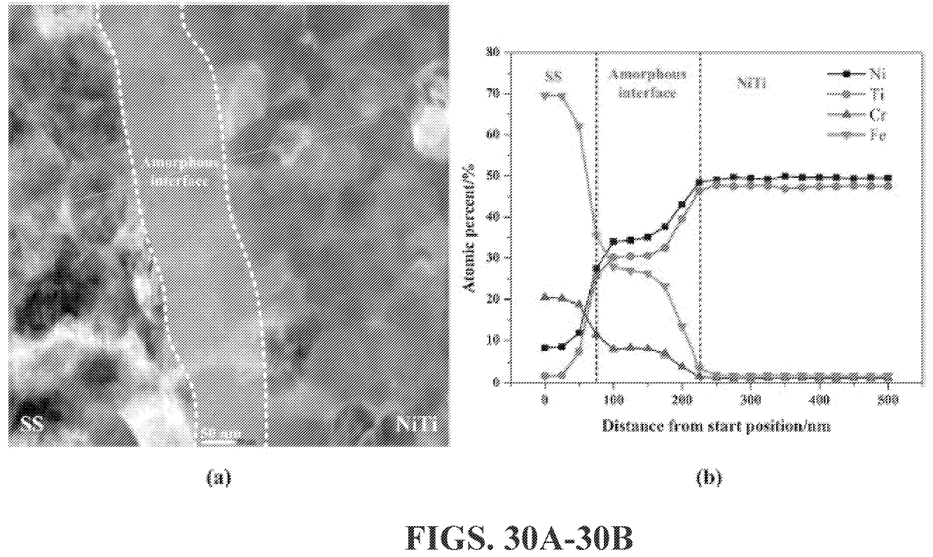

The composition of the amorphous layer could assist in the understanding of the bonding mechanism of NiTi/SS impact welds. FIG. 30 shows the bright field image of the SS-NiTi weld interface and the corresponding EDS analysis across this weld interface. It is possible that local heating in this 100 nm layered zone (due to friction or compressed gas heating during impact) caused some local melting, mixing and resolidification. This interface is too thick to be attributed to common solid-state diffusion during the impact process, however, deformation assisted mixing cannot be ruled out.

3.2.3. Formation Mechanisms of Amorphous Phases in NiTi/SS Impact Welds

It seems clear that at least some material pairs form amorphous intermediate regions in impact welding. In this work, the grain sizes of in the NiTi and SS near the amorphous layer are at nanometer scales, less than 100 nm. This indicates that solid-state amorphization probably happened in the interface of the NiTi/SS impact welds.

The amorphous zone can be explained as due to the rapid cooling and frustrated crystallization in a multi-component melt. In explosive welding, the heating rate could reach 10\hat{ }9 K/s and the cooling rate could reach 10\hat{ }7 K/s, results in the formation of various metastable phases including amorphous phases. High heating and cooling rates, on the order of 10\hat{ }7 K/s, were also observed in VFAW of single crystal copper. The amorphous zones are less than 100 nm (e.g., less than 75 nm, less than 50 nm, or less than 25 nm) in thickness and are so small such that they are negligible relative to the characteristics of the weld.

The easiest alloys to make amorphous are those with a wide range of elements and element sizes. The alloys system reaching the following three requirements should have good glass forming ability (GFA):

1) Contains at least 3 atomic species;

2) 12% or more difference in the size of the atoms, and

3) Negative enthalpy of mixing of the elements in the liquid phase.

In the present case, there are 4 major atomic species in the amorphous forming area. The atomic radius is 17.6 nm for Ti, 14.9 nm for Ni, 12.6 nm for Fe, and 128 nm for Cr. Therefore, the difference in radius between Ti and other elements is approximately 15.3% for Ni, 28.4% for Fe, and 27.3% for Cr. Furthermore, the mixing enthalpy of the studied composition is about −9.2 kJ/mol, calculated via Thermo-Calc listed in Table 2. All the three requirements are fulfilled in the amorphous interface of NiTi/SS impact welds. Clear methodologies have been developed for predicting GFA potential which showed that the alloy system with compositions at or near eutectics should have good glass forming ability. In an alloy at or near the eutectic composition, the liquid phase can be kept to the lowest temperature, at which viscosity increases, diffusion slows down, and the amorphous structure more easily forms. In addition, the material crystallizes at equilibrium into 2 phases, resulting in the need for alloying elements to partition between phases and complicating crystallization kinetics.

TABLE 2
Enthalpies of various systems at the liquidus of the studied
composition of Example 2.

| | Studied | | | | | |
|---|---|---|---|---|---|---|
| System | composition | Ni | Ti | Fe | Cr | Mixing |
| Enthalpy, | 37.6 | 44.6 | 45.6 | 51.5 | 45.6 | −9.2 |
| kJ/mol | | | | | | |
| at.% | 1 | 34.35 | 30.48 | 27.00 | 8.17 | |

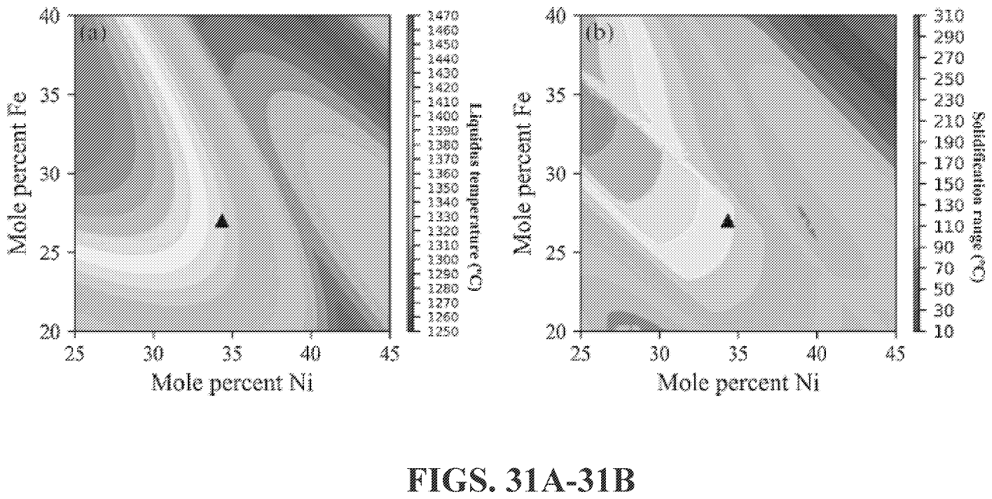

FIG. 31 shows the liquidus temperature and solidification range calculated via Thermo-Calc. The composition of the amorphous layer in the studied sample is located near a minimum in both liquidus temperature and solidification range. Thus, the viscosity of the liquid should be high, and atoms are difficult to diffuse and to form two phases simultaneously. This assist in retaining the amorphous state. Overall, the composition in this area should have good GFA and it will be easy to form amorphous phases, corresponding to the TEM-EDS results shown in FIG. 30.

3.3. Phase Transformation Characteristics

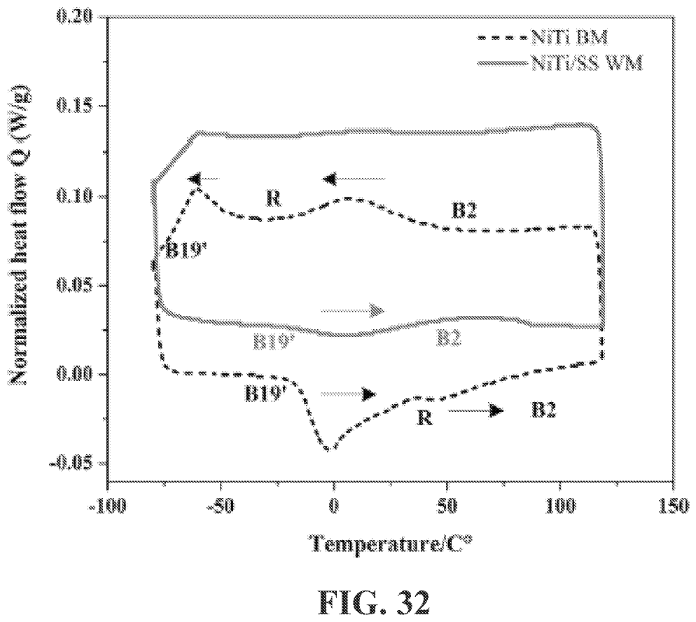

Phase transformation characteristics are good indicators for functional properties of NiTi shape memory alloys. After high speed impact welding, phase transformation temperatures can be expected to change due to the high strain rate plastic deformation involved in the VFAW process. High strain rate plastic deformation is known to suppress the martensitic transformation and thus widen the transformation temperature range. The phase transformation curves of the NiTi base metal and NiTi/SS weld were shown in FIG. 32. For NiTi base metal, a two-step reversible B2-R-B19′ transformation was shown in the cooling and heating stage. The formation of R phase in this case is likely due to the formation of Ni4Ti3 precipitates in the NiTi base metal caused by the annealing before welding, as was seen in laser welding of NiTi alloys. Since no DSC tests were done on the original NiTi base metal, it is also possible that these precipitates were formed during the manufacturing process.

After VFAW, no obvious transformation peak was observed in the cooling stage and a one step B19′→B2 transformation was shown in the heating stage. The martensitic transformation has been significantly suppressed by the high-speed impact. One reason is that the high strain rate plastic deformation makes the microstructure of NiTi more constricted, which impeded the martensitic transformation upon cooling. The other could be due to the influence of the inactive SS being half of the gauge length in the DSC sample. The limited transformation occurring at the heating stage could also be interpreted as the overlapping effect of NiTi base metal in the DSC sample for NiTi/SS weld, which is under the detection limits of the DSC instruments.

3.4. Mechanical Properties

The mechanical properties and behavior of these welds are interesting as they can provide macroscopic joints between these important dissimilar materials. This high-level behavior is the result of the complex and heterogeneous structure described to this point. The local hardness will be discussed first and then this will be integrated into the discussion of macroscopic behavior.

3.4.1. Hardness Distributions

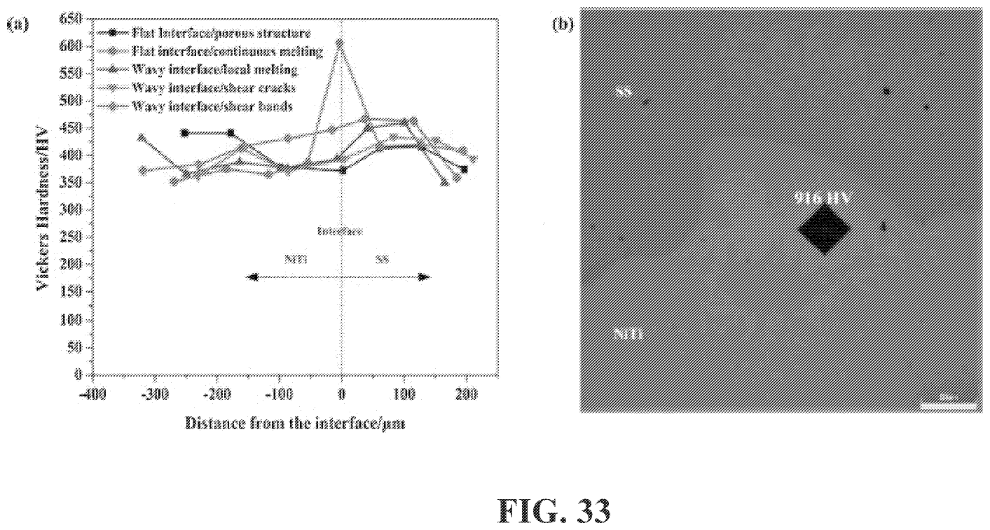

The microstructural heterogeneity will result in variations of mechanical properties such as microhardness distributions among different interfaces. FIG. 33a compares microhardness distributions across the interfaces discussed in FIG. 21. In most cases the hardness traverses are relatively flat, often with some minor increase in hardness, particularly on the SS side. For the flat interface with continuous melting, the hardness at the interface is significantly higher than that of the base metals, likely due to hard intermetallic or amorphous phases at the interface. The microhardness values of the other interfaces are comparable with those of the base metals. FIG. 33b shows the microhardness and indent of the molten zone in the wavy interface with discontinuous melting. The microhardness of this molten zone reaches 916 HV which is over two times the hardness of base metals. The microhardness distributions confirmed that there is no heat affected zone formed near the interface in NiTi/SS impact welds, which is one of the major reasons for the high strength of the NiTi/SS impact welds.

3.4.2. Comparison of Joint Efficiency with Other Welding Technologies

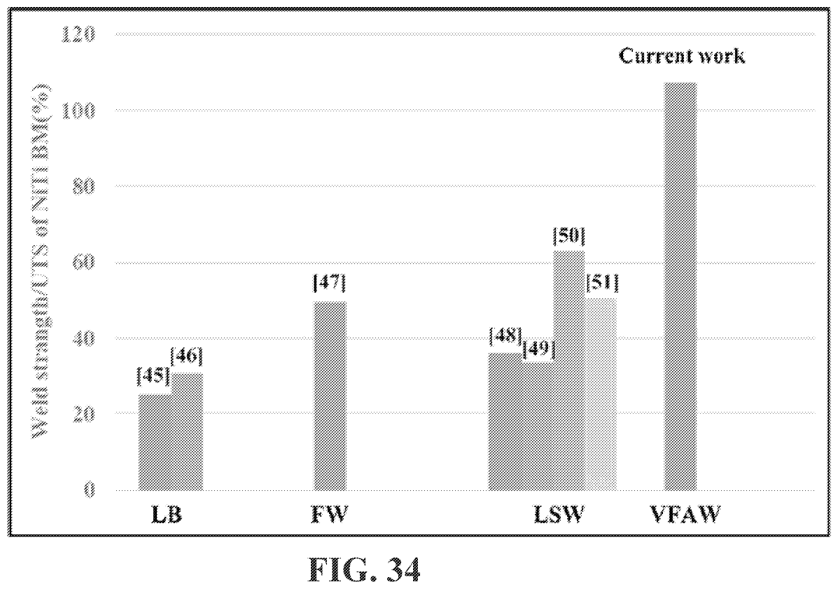

A primary goal of undertaking this kind of research is the production of joints that have strength on par with, or exceeding, those of the base metals. In particular it is important that the full pseudo-elastic transition in the NiTi can be accessed after joining with SS, as shown in FIG. 34. Joint efficiency, the ratio of the weld strength to the ultimate tensile strength (UTS) of NiTi base metal, is a good indicator to compare welding technologies for a given material pair. Since strain is very heterogeneous over the sample and localized in the weaker material (NiTi), the UTS of NiTi base metal instead of that of SS is used to examine the joint efficiency. FIG. 34 compares the joint efficiencies of three methods from literature including laser brazing, friction welding, laser welding and VFAW used in this work. The efficacy of impact welding to join this important pair was examined in simple preliminary testing in the lap shear mode. NiTi/SS VFA welds fractured at the NiTi base metal after lap shear testing and entail 100% of the UTS of NiTi base metal, which is much higher than those of other methods (28-62%). In laser brazing, weak bonding between NiTi SMA and filler metal as well as the structural coarsening in the NiTi HAZ significantly decrease the joint strength. In friction welding of NiTi to SS, the use of Ni interlayer prevents the formation of Fe2Ti intermetallics but the joint efficiency is still low mainly due to the formation of HAZ and TMAZ. In laser welding of NiTi to SS, the HAZ and IMC formation due to melting of NiTi and SS are the two main reasons for the lower joint efficiency compared to that in VFAW. The lack of a HAZ VFAW is one of the major reasons for the superior joint efficiency of VFAW. While these joints are relatively heterogeneous, large areas of the welds achieve reliable atomic scale joining even with some unbonded zones and melting in the weld center which together do not adversely affect the mechanical properties of the overall weldment. This is similar to observations of VFAW of Al to steel, while Al-Steel VFA welds present defects such as voids and intermetallics, they maintain high lap shear strength and fatigue performance.

The devices and methods of the appended claims are not limited in scope by the specific devices and methods described herein, which are intended as illustrations of a few aspects of the claims. Any compositions, systems, and methods that are functionally equivalent are intended to fall within the scope of the claims. Various modifications of the compositions, systems, and methods in addition to those shown and described herein are intended to fall within the scope of the appended claims. Further, while only certain representative compositions, systems, and method steps disclosed herein are specifically described, other combinations of the compositions, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

Unless defined otherwise, all technical and scientific terms used herein have the same meanings as commonly understood by one of skill in the art to which the disclosed invention belongs. Publications cited herein and the materials for which they are cited are specifically incorporated by reference

What is claimed is:

1. A method of joining a first metal to a second metal, the method comprising:
positioning a metallic consumable body proximate to a piece of the first metal;
accelerating the piece of the first metal by vaporizing the metallic consumable body and directing the gas pressure generated by the vaporized metallic consumable body into the piece of the first metal; and
colliding the accelerated piece of the first metal into a stationary piece of the second metal, thereby joining the piece of the first metal to the stationary piece of the second metal;
wherein the first metal, the second metal, or a combination thereof comprises a shape memory alloy.

2. The method of claim 1, wherein the consumable body comprises a foil.

3. The method of any of claims 1-2, wherein the metallic consumable body comprises aluminum.

4. The method of any of claims 1-3, wherein the stationary piece of the second metal is a die and the piece of the first metal is deformed by the collision to create a desired shape or surface structure.

5. The method of claim 4, wherein the die contains holes, such that the piece of the first metal is perforated or sheared by the collision to create a desired hole or a series of holes or interlocking features.

6. The method of any of claims 1-5, wherein the first metal and the second metal comprise dissimilar metals.

7. The method of any of claims 1-6, wherein the first metal comprises stainless steel, and the second metal comprises a nickel-titanium shape memory alloy.

8. The method of any of claims 1-6, wherein the first metal comprises a nickel-titanium shape memory alloy, and the second metal comprises stainless steel.

9. The method of any of claims 1-8, wherein the first metal, the second metal, or a combination thereof comprise a nickel-titanium shape memory alloy.

10. The method of any of claims 1-9, wherein the first metal and the second metal comprise a nickel-titanium shape memory alloy.

11. The method of any of claims 7-10, wherein the nickel-titanium shape memory alloy comprises a nickel-titanium (NiTi) alloy, a nickel-titanium-iron (Ni—Ti—Fe) alloy, a nickel-titanium-copper (Ni—Ti—Cu) alloy, a nickel-titanium-lead (Ni—Ti—Pb) alloy, or a nickel-titanium-hafnium (Ni—Ti—Hf) alloy.

12. The method of any of claims 1-11, wherein the shape memory alloy comprises nitinol.

13. The method of any of claims 1-12, wherein the first metal, the second metal, or a combination thereof comprise a Ni—Ti—Hf—Zr shape memory alloy.

14. The method of any of claims 1-13, wherein the first metal, the second metal, or a combination thereof comprise a NiTi—Er shape memory alloy.

15. The method of any of claims 1-14, wherein the first metal, the second metal, or a combination thereof comprise a nickel alloy.

16. The method of any of claims 1-15, wherein the first metal, the second metal, or a combination thereof comprise a radio-opaque alloy.

17. The method of claims 1-16, wherein the first metal, the second metal, or a combination thereof comprises an advanced structural metal.

18. The method of claims 1-17, wherein the first metal, second metal, or a combination thereof comprises a high entropy alloy.

19. The method of claims 1-18, wherein the first metal, second metal, or a combination thereof comprises a refractory metal.

20. The method of any of claims 1-19, wherein the first metal, the second metal, or a combination thereof comprise a refractory alloy.

21. The method of claims 1-20, wherein the first metal, second metal, or a combination thereof comprises an amorphous metal.

22. The method of any of claims 1-21, wherein in the accelerating step, the piece of the first metal attains a velocity in the range of 300 to 1000 m/s.

23. The method of any of claims 1-22, wherein the accelerating step is achieved by passing a current rapidly into the consumable body.

24. The method of claim 23, wherein the current is achieved by discharging a capacitor.

25. The method of claim 24, wherein the capacitor provides an input energy in the range of 100 joules to 100 kilojoules.

26. The method of any of claims 1-25, wherein the piece of the first metal and the stationary piece of the second metal are arranged in that order between a pair of blocks of material, each of which significantly outweighs the piece of the first metal, thereby directing the vaporized stream towards the piece of the first metal and accelerating the piece of the first metal towards the stationary piece of the second metal.

27. The method of any of claims 1-26, further comprising positioning a plurality of standoff sheets between the piece of the first metal and the stationary piece of the second metal, each of the standoff sheets having a same standoff sheet thickness.

28. The method of claim 27, wherein the standoff sheet thickness ranges from 0.1 mm to 1 cm.

29. The method of claims 1-28, wherein the piece of the first metal comprises a shape memory alloy, and the stationary piece of the second metal comprises a casting.

30. The method of claims 1-29, wherein the piece of the first metal has a first thickness, the stationary piece of the second metal has a second thickness, and the first thickness is 20% less than the second thickness.

31. The method of any of claims 1-30, wherein the piece of the first metal has a thickness of from 10 μm to 4 cm.

32. The method of any of claims 1-31, wherein the stationary piece of the second metal has a second thickness, the second thickness ranging from 10 μm to 4 cm.

33. The method of any of claims 20-32, wherein the piece of the first metal and the stationary piece of the second metal are joined with a scarf weld and form a joined piece.

34. The method of claim 33, wherein the piece of the first metal and the stationary piece of the second metal are wires.

35. The method of claim 34, further comprising machining the piece of the first metal and the piece of the second metal into a desired shape.

36. A method of joining a first metal to a second metal, the method comprising:
positioning a piece of the first metal over an upper surface of a stationary piece of the second metal at a first distance, the piece of the first metal being positioned at an oblique angle with respect to the upper surface of the stationary piece of the second metal;
positioning a target layer over at least a first location of the piece of the first metal directing a laser beam to be incidental to the first location of the piece of the first metal for a first duration;
accelerating the piece of the first metal to a first velocity and towards the upper surface of the stationary piece of the second metal, thereby joining the piece of the first metal to the stationary piece of the second metal;
wherein the first metal, the second metal, or a combination thereof comprises a shape memory alloy.

37. The method of claim 36, wherein the target layer comprises a tamping layer.

38. The method of claim 37, wherein positioning the tamping layer comprises flowing water over the piece of the first metal, the water forming the tamping layer.

39. The method of claim 38, wherein the target layer comprises an ablative layer.

40. The method of claim 39, wherein the ablative layer comprises a carbonaceous material, a cellulosic material, nitromethane-based material, azide-based material, oxidizer-oxidant material, nanopowder material, or any combination thereof.

41. The method of any of claims 38-40, wherein the target layer further comprises a transparent backing disposed on the ablative layer.

42. The method of claim 41, wherein the transparent backing comprises sapphire, quartz, glass, a polymer, or any combination thereof.

43. The method of any of claims 36-42, wherein the first distance is from 0.1 mm to 1 cm.

44. The method of any of claims 36-43, wherein the first velocity is between 300 meters/sec and 1000 meters/sec.

45. The method of any of claims 36-44, wherein the oblique angle is in the range of 5 to 30 degrees.

46. The method of any of claims 36-45, wherein the first duration is between 5 ns and 500 ns.

47. The method of any of claims 36-46, wherein the first metal and the second metal comprise dissimilar metals.

48. The method of any of claims 36-47, wherein the first metal comprises stainless steel, and the second metal comprises a nickel-titanium shape memory alloy.

49. The method of any of claims 36-48, wherein the first metal comprises a nickel-titanium shape memory alloy, and the second metal comprises stainless steel.

50. The method of any of claims 36-49, wherein the first metal, the second metal, or a combination thereof comprise a nickel-titanium shape memory alloy.

51. The method of any of claims 36-50, wherein the first metal and the second metal comprise a nickel-titanium shape memory alloy.

52. The method of any of claims 48-51, wherein the nickel-titanium shape memory alloy comprises a nickel-titanium (NiTi) alloy, a nickel-titanium-iron (Ni—Ti—Fe) alloy, a nickel-titanium-copper (Ni—Ti—Cu) alloy, a nickel-titanium-lead (Ni—Ti—Pb) alloy, or a nickel-titanium-hafnium (Ni—Ti—Hf) alloy.

53. The method of any of claims 36-52, wherein the shape memory alloy comprises nitinol.

54. The method of any of claims 36-53, wherein the first metal, the second metal, or a combination thereof comprise a Ni—Ti—Hf—Zr shape memory alloy.

55. The method of any of claims 36-54, wherein the first metal, the second metal, or a combination thereof comprise a NiTi—Er shape memory alloy.

56. The method of any of claims 36-55, wherein the first metal, the second metal, or a combination thereof comprise a nickel alloy.

57. The method of any of claims 36-56, wherein the first metal, the second metal, or a combination thereof comprise a radio-opaque alloy.

58. The method of claims 36-57, wherein the first metal, the second metal, or a combination thereof comprises an advanced structural metal.

59. The method of claims 36-58, wherein the first metal comprises a shape memory alloy, and the second metal comprises a casting.

60. The method of claims 36-59, wherein the first metal, second metal, or a combination thereof comprises a high entropy alloy.

61. The method of claims 36-60, wherein the first metal, second metal, or a combination thereof comprises a refractory metal.

62. The method of any of claims 36-61, wherein the first metal, the second metal, or a combination thereof comprise a refractory alloy.

63. The method of claims 36-62, wherein the first metal, second metal, or a combination thereof comprises an amorphous metal.

64. A device comprising a weld joining a first metal to a second metal,
wherein the first metal, the second metal, or a combination thereof comprises a shape memory alloy,
wherein the shape memory alloy has an ultimate tensile strength, and
wherein the weld exhibits a joint efficiency of at least 63% relative to the ultimate tensile strength of the shape memory alloy.

65. The device of claim 64, wherein the weld exhibits a joint efficiency of at least 80%.

66. The device of claim 64-65, wherein the weld has substantially no heat affected zones.

67. The device of claims 64-66, wherein the weld has substantially no brittle intermetallics.

68. A device comprising a weld joining a first metal to a second metal,
wherein the first metal, the second metal, or a combination thereof comprises a shape memory alloy,
wherein the weld has substantially no heat affected zones.

69. The device of claim 68, wherein the weld exhibits a joint efficiency of at least 63%.

70. The device of claim 68-69, wherein the weld exhibits a joint efficiency of at least 80%.

71. The device of claims 68-70, wherein the weld has substantially no brittle intermetallics.

72. A device comprising a weld joining a first metal to a second metal,
wherein the first metal, the second metal, or a combination thereof comprises a shape memory alloy,
wherein the weld has substantially no brittle intermetallics.

73. The device of claim 72, wherein the weld exhibits a joint efficiency of at least 63%.

74. The device of claim 72-73, wherein the weld exhibits a joint efficiency of at least 80%.

75. The device of claims 72-74, wherein the weld has substantially no heat affected zones.

76. The device of any of claims 64-75, wherein the first metal and the second metal comprise dissimilar metals.

77. The device of any of claims 64-76, wherein the first metal comprises stainless steel, and the second metal comprises a nickel-titanium shape memory alloy.

78. The device of any of claims 64-76, wherein the first metal comprises a nickel-titanium shape memory alloy, and the second metal comprises stainless steel.

79. The device of any of claims 64-78, wherein the first metal, the second metal, or a combination thereof comprise a nickel-titanium shape memory alloy.

80. The device of any of claims 64-79, wherein the first metal and the second metal comprise a nickel-titanium shape memory alloy.

81. The device of any of claims 77-80, wherein the nickel-titanium shape memory alloy comprises a nickel-titanium (NiTi) alloy, a nickel-titanium-iron (Ni—Ti—Fe) alloy, a nickel-titanium-copper (Ni—Ti—Cu) alloy, a nickel-titanium-lead (Ni—Ti—Pb) alloy, or a nickel-titanium-hafnium (Ni—Ti—Hf) alloy.

82. The device of any of claims 64-81, wherein the shape memory alloy comprises nitinol.

83. The device of any of claims 64-82, wherein the first metal, the second metal, or a combination thereof comprise a Ni—Ti—Hf—Zr shape memory alloy.

84. The device of any of claims 64-83, wherein the first metal, the second metal, or a combination thereof comprise a NiTi—Er shape memory alloy.

85. The device of any of claims 64-84, wherein the first metal, the second metal, or a combination thereof comprise a nickel alloy.

86. The device of any of claims 64-85, wherein the first metal, the second metal, or a combination thereof comprise a radio-opaque alloy.

87. The device of any of claims 64-86, wherein the first metal, the second metal, or a combination thereof comprises an advanced structural metal.

88. The device of any of claims 64-87, wherein the first metal comprises a shape memory alloy, and the second metal comprises a casting.

89. The device of any of claims 64-88, wherein the first metal, second metal, or a combination thereof comprises a high entropy alloy.

90. The device of any of claims 64-89, wherein the first metal, second metal, or a combination thereof comprises a refractory metal.

91. The device of any of claims 64-90, wherein the first metal, the second metal, or a combination thereof comprise a refractory alloy.

92. The device of any of claims 64-91, wherein the first metal, second metal, or a combination thereof comprises an amorphous metal.

93. The device of any of claims 64-92, wherein the weld is a single wire weld, a plurality of wire welds, a lap weld, a scarf weld, a ring/sleeve weld, a plug weld, or an additive flyer weld.

94. The device of any of claims 64-93, wherein the device is an actuator.

95. The device of any of claims 64-93, wherein the device is a wire.

96. The device of any of claims 64-93, wherein the device is a medical device.

97. The device of claim 96, wherein the medical device is a stent.

98. The device of claim 96, wherein the medical device is a guidewire.

99. The device of claim 96, wherein the medical device is an implant.

100. The device of claim 96, wherein the medical device is a surgical tool.
